(19) United States
(12) Patent Application Publication
(10) Pub. No.: US 2005/0254835 A1
(43) Pub. Date: Nov. 17, 2005

(54) Image formation apparatus to which replacement unit is attached and image formation system

(75) Inventor: Kenichi Takei, Saitama (JP)

Correspondence Address: OLIFF & BERRIDGE, P.O. BOX 19928, ALEXANDRIA, VA, 22320, US

(73) Assignee: FUJI XEROX CO., LTD.

(21) Appl. No.: 11/041,242

(22) Filed: Jan. 25, 2005

(30) Foreign Application Priority Data
May 17, 2004 (JP) P.2004-146146
May 17, 2004 (JP) P.2004-146147

(51) Int. Cl. G03G 15/00; G03G 15/08

(52) U.S. Cl. 399/12; 399/27; 399/82; 399/110

(57) ABSTRACT

An image formation apparatus is determined whether a replacement unit attached to the image formation apparatus is a genuine product or a product other than the genuine product, and the image formation apparatus is determined whether the replacement unit is a recycled product or not. When the image formation apparatus is the recycled product and the image formation apparatus is determined that recycling display is performed, the recycling display is added to a print. The image formation apparatus is controlled in a genuine product mode when the replacement unit is the genuine product, and is controlled in a non-genuine product mode when the replacement unit is the product other than the genuine product.

### BACKGROUND OF THE INVENTION

1. Field of the Invention

The present invention relates to an image formation apparatus, and more specifically to means in which a replacement unit is replaceably attached to an apparatus body.

2. Background Art

As an image formation apparatus, means constructed so that a user can easily replace a unit including a consumable product etc. is known.

On the other hand, when the unit replaced by the user is a product other than a genuine product with respect to the image formation apparatus, there are cases where, for example, reduction in image quality, performance of the image formation apparatus cannot be offered sufficiently, an operation cannot be guaranteed or trouble such as failure occurs. This is because the image formation apparatus controls a process of image formation in consideration of characteristics of toner, characteristics of an image carrier, electrification voltage, cleaning characteristics and fixing characteristics, etc.

Thus, in order to maintain image quality of an image formation apparatus and prevent trouble, a method for providing a data carrier for holding consumption amount data of a consumable product in a genuine replacement component and determining whether or not the consumable product is supplied to the genuine replacement component by comparing the consumption amount data held by the data carrier with the consumption amount detected by a consumption amount detection part provided inside a body of the apparatus is disclosed in JP-A-10-133528.

Also, means for providing storage means for storing predetermined code data in a toner cartridge and inhibiting copying when the body side of a copying machine cannot read the predetermined code data from the storage means is disclosed in JP-A-6-149051.

Also, a method for performing warning display and print inhibition when empty information written on a cartridge is read out of the cartridge to which toner is supplied in the case of detecting lack of toner is disclosed in JP-A-2001-100598.

Also, a method for storing a count of a created image in memory of a cartridge and subsequently disabling the cartridge when the count of the created image is equal to a preset end count indicating the number of images capable of being created in the cartridge is disclosed in Japanese Patent No. 2,602,341.

Further, a method in which when it is determined that a toner supply container attached is a mismatch by two-way communication between container side communication means of the toner supply container and body side communication means of an apparatus body and continuation of supply processing by ignoring the mismatch is selected by selection input means, an image formation condition which is leveled down than a proper image formation condition is set and finding of the fact that the toner supply container is the mismatch is facilitated is disclosed in Japanese Patent No. 3,476,704.

By the way, even when a replacement unit is a genuine product or a product other than the genuine product, there is a recycled product in which a body of the replacement unit is left as it is and a portion of the component is replaced or, for example, reproduction is performed by supplying toner. Such a recycled product is an environmentally friendly product since a newly manufactured portion is smaller as compared with a newly manufactured product.

However, in the conventional art, use of such a recycled product was not displayed and an appeal for consideration of environment using the recycled product could not be made.

### SUMMARY OF THE INVENTION

A first object of the invention is to provide an image formation apparatus capable of actively making an appeal for the fact that a recycled product is used in a replacement unit.

A second object of the invention is to provide an image formation apparatus and an image formation system capable of using a replacement unit which is a product other than a genuine product by user's intention even when a replacement unit which is a product other than a genuine product is attached. Also, a second object of the invention is to provide an image formation apparatus and an image formation system in which when a replacement unit which is a product other than a genuine product is attached, a user can recognize a situation to that effect.

In order to achieve the objects, a first aspect of the invention resides in an image formation apparatus having an apparatus body, at least one replacement unit replaceably attached to this apparatus body, a determination unit for determining whether this replacement unit is a recycled product or not, and a control unit for performing control so that display to the effect that the recycled product is used is printed on paper in the case of determining that the replacement unit is recycling as a result of determination of this determination unit. Therefore, the fact that the replacement unit is the recycled product can automatically be printed on paper, so that a user of the image formation apparatus can appeal to other persons to use an environmentally friendly replacement unit.

Incidentally, a recycled product herein refers to a product recycled by newly replacing or supplying a component or material such as toner, and does not make any distinction as to whether to be a genuine product or a product other than the genuine product.

It is preferable to have a display/non-display selection unit for selecting whether display to the effect that the recycled product is used is performed or not.

Also, it is preferable to have an editing unit for editing a form of display to the effect that the recycled product is used. The form of display includes display by an image as well as display by language. Also, black and white display, color display or watermark (hidden display) can also be performed.

Also, it is preferable to have a display position selection unit for selecting a position of display to the effect that the recycled product is used with respect to paper. The position of display includes a margin portion of paper of a header, a footer, etc. of paper or a back portion of paper.

Also, it is preferably constructed so that a plurality of the replacement units are had every color and the control unit performs display to the effect that the recycled product is used every color.

Also, a second aspect of the invention resides in an image formation apparatus having an apparatus body, at least one replacement unit replaceably attached to this apparatus body, a first determination unit for determining whether this replacement unit is a genuine product or a product other than the genuine product, a second determination unit for determining whether the replacement unit is a recycled product or not, and a control unit for performing control so that display to the effect that the recycled product is used is printed on paper in the case of determining that the replacement unit is the product other than the genuine product as a result of determination of the first determination unit and determining that the replacement unit is recycling as a result of determination of the second determination unit.

Also, a third aspect of the invention resides in an image formation apparatus having an apparatus body, at least one replacement unit replaceably attached to this apparatus body, a first determination unit for determining whether this replacement unit is a genuine product or a product other than the genuine product, a second determination unit for determining whether the replacement unit is a recycled product or not, and a control unit for performing control so that display to the effect that the recycled product is used is printed on paper in the case of determining that the replacement unit is the genuine product as a result of determination of the first determination unit and determining that the replacement unit is recycling as a result of determination of the second determination unit.

In order to achieve the objects, a fourth aspect of the invention resides in an image formation apparatus having an apparatus body, at least one replacement unit replaceably attached to this apparatus body, a determination unit for determining whether this replacement unit is a genuine product or a product other than the genuine product, and a control unit for performing control so that in the case of determining that the replacement unit is the product other than the genuine product as a result of determination of this determination unit, printing to that effect is done on paper. Therefore, even when the product other than the genuine product is attached as the replacement unit, the operation can be performed and the printing to that effect is done on paper, so that a user can recognize that the product other than the genuine product is attached as the replacement unit.

It is preferably constructed so that a plurality of the replacement units are had every color and the control unit performs display to the effect that the product other than the genuine product is used every color.

Also, it is preferable to further have a print timing selection unit for selecting print timing to the effect that the replacement unit is the product other than the genuine product with respect to paper. This print timing selection unit preferably includes at least one selected from a power-on time selection part for making a selection so as to do printing to the effect that the replacement unit is the product other than the genuine product with respect to paper at the time of turning on a power source, a predetermined sheet basis selection part for making a selection so as to do printing to the effect that the replacement unit is the product other than the genuine product with respect to paper on a predetermined sheet print basis, or a specification time selection part for making a selection so as to do printing to the effect that the replacement unit is the product other than the genuine product with respect to paper at the time of specification. Also, the specification time selection part can do printing to the effect that the replacement unit is the product other than the genuine product with respect to paper at the time of inputting a specification signal from the inside, for example, an operation panel, or can do printing to the effect that the replacement unit is the product other than the genuine product with respect to paper at the time of inputting a specification signal from the outside, for example, a client PC connected to the image formation apparatus.

Also, it is preferable to have a accounting unit for performing accounting with respect to printing of paper and have an accounting control unit for performing non-accounting with respect to printing of paper on which printing to the effect that the replacement unit is the product other than the genuine product is done by the control unit.

Also, a fifth aspect of the invention resides in an image formation system having an image formation apparatus and a host apparatus connected to this image formation apparatus, wherein the image formation apparatus has an apparatus body, at least one replacement unit replaceably attached to this apparatus body, a determination unit for determining whether this replacement unit is a genuine product or a product other than the genuine product, and a control unit for performing control so that in the case of determining that the replacement unit is the product other than the genuine product as a result of determination of this determination unit, printing to that effect is done on paper, and the host apparatus has a print timing selection unit for selecting print timing to the effect that the replacement unit is the product other than the genuine product with respect to paper.

According to the invention, even when a replacement unit which is a product other than a genuine product is attached, a replacement unit which is a product other than a genuine product can be used by user is intention and in that case, it is constructed so that printing to the effect that the replacement unit is the product other than the genuine product is done on paper, so that a user can recognize a situation to that effect.

### BRIEF DESCRIPTION OF THE DRAWINGS

These and other objects and advantages of this invention will become more fully apparent from the following detailed description taken with the accompanying drawings in which:

FIG. 1 is a schematic diagram of an image formation system according to an embodiment of the invention;

FIG. 2 is a side view showing an outline of an image formation apparatus according to the embodiment of the invention;

FIG. 3 is a side view illustrating a state of detaching a replaceable unit of the image formation apparatus according to the embodiment of the invention from an image formation apparatus body;

FIG. 4 is a perspective view showing a developing device of the image formation apparatus according to the embodiment of the invention;

FIG. 5 is a schematic view showing a cross section of the developing device of the image formation apparatus according to the embodiment of the invention;

FIG. 6 is a perspective view showing a toner cartridge of the image formation apparatus according to the embodiment of the invention;

FIG. 7 is a sectional view showing the toner cartridge of the image formation apparatus according to the embodiment of the invention;

FIG. 8 is a block diagram showing a circuit configuration of a wireless communication part of the image formation apparatus according to the embodiment of the invention;

FIG. 9 is a block diagram showing a circuit configuration of a memory chip of the toner cartridge used in the image formation apparatus according to the embodiment of the invention;

FIG. 10 is a sectional view showing a position relation between the memory chip and the wireless communication part for conducting wireless communication;

FIG. 11 is a side view showing a configuration of an image carrier unit used in the image formation apparatus according to the embodiment of the invention;

FIG. 12 is a block diagram showing a configuration of a control part of the image formation apparatus according to the embodiment of the invention and each part connected to the control part;

FIG. 13 is a memory map illustrating data stored in program ROM, body NVM and unit NVM;

FIG. 14 is a graph showing a change in electrification capability of a developer versus a developer use amount (life count value) stored in the body NVM;

FIG. 15 is a graph showing setting for correcting a change in electrification capability of a developer and is a graph showing setting of an image density versus a developer use amount;

FIGS. 16A and 16B are graphs showing a result corrected by the setting shown in FIG. 15 and FIG. 16A is a graph showing a toner density corrected and FIG. 16B is a graph showing an image density corrected;

FIG. 17 is a block diagram showing a portion of a software configuration stored in the program ROM as an execution program;

FIG. 18 is a flowchart (S10) showing a control flow of the case of attaching a replacement unit;

FIGS. 19A to 19C are diagrams showing screen display of a user interface or a host apparatus;

FIG. 20 is a flowchart (S20) showing a modified example;

FIG. 21 is a memory map illustrating data stored in program ROM, body NVM and unit NVM;

FIG. 22 is a block diagram showing a portion of a software configuration stored in the program ROM as an execution program;

FIG. 23 is a flowchart (S1010) showing a control flow of the case of attaching a replacement unit;

FIGS. 24A and 24B are diagrams showing screen display of a user interface or a host apparatus;

FIG. 25 is a flowchart (S1020) showing a first modified example;

FIG. 26 is a configuration diagram showing hardware of the host side in a second modified example;

FIG. 27 is a configuration diagram showing software of the host side in the second modified example; and

FIG. 28 is a diagram showing an information print screen in the second modified example.

### DETAILED DESCRIPTION OF THE PREFERRED EMBODIMENTS

### First Embodiment

An embodiment of the invention will be described based on the drawings.

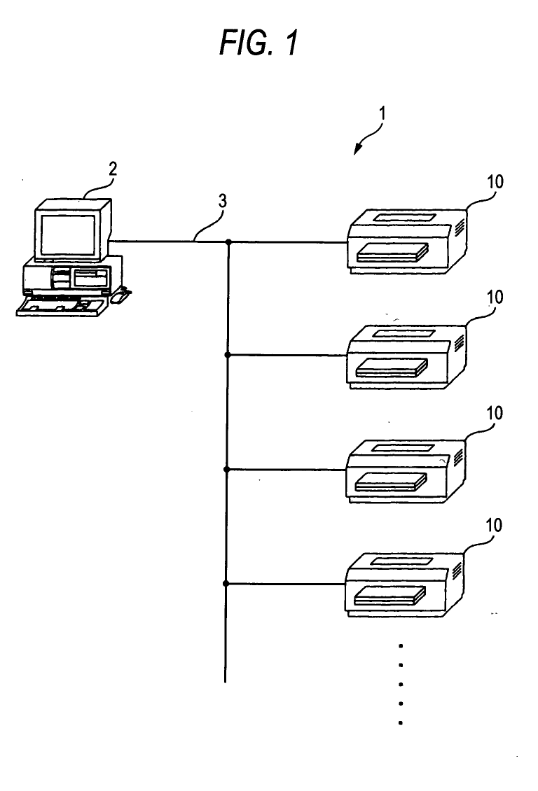

In FIG. 1, an image formation system 1 according to an embodiment of the invention is shown. The image formation system 1 is configured by connecting a host apparatus 2 such as a PC (Personal Computer) to, for example, plural image formation apparatus 10 through a network 3. The host apparatus 2 may be, for example, a controller such as an MCU (Micro Controller Unit), an input/output unit such as a touch panel, and a terminal other than a PC having a communication unit for sending and receiving a signal through the network 3. The network 3 may be wired or wireless. Also, the plural host apparatus 2 may be connected to the network 3.

Thus, the image formation system 1 is configured so that the host apparatus 2 can control the image formation apparatus 10 through the network 3.

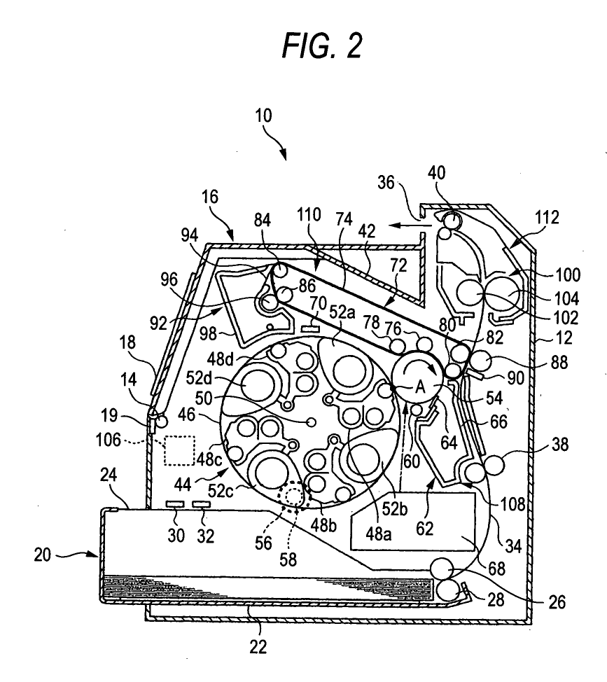

In FIG. 2, an outline of the image formation apparatus 10 is shown. The image formation apparatus 10 has an image formation apparatus body 12, and an opening and closing cover 16 rotatable around a rotation fulcrum 14 is provided in an upper portion of this image formation apparatus body 12. A user interface (UI device) 18 such as a touch panel is provided in the front side (left side in FIG. 2) of the opening and closing cover 16. The UI device 18 displays instruction information or control information about the image formation apparatus 10 and also accepts an input by a user of the instruction information etc. That is, the user can operate the image formation apparatus 10 through the UI device 18. Incidentally, the UI device 18 may be means for accepting only an input of a switch etc., means for producing only an output of display etc., or combinations of these means.

Also, an opening and closing detection sensor 19 for detecting opening and closing of the opening and closing cover 16, for example, by making or losing contact according to opening and closing of the opening and closing cover 16 is provided in the vicinity of the rotation fulcrum 14.

A paper feeding unit 20 of, for example, one stage is arranged in a lower portion of the image formation apparatus body 12. The paper feeding unit 20 has a paper feeding unit body 22 and a paper feeding cassette 24 in which paper is accommodated. A feed roll 26 for feeding paper from the paper feeding cassette 24 and a retard roll 28 for handling the fed paper one by one are arranged in an upper portion near to the back end of the paper feeding cassette 24. Also, a temperature sensor 30 for detecting temperature of the inside of the image formation apparatus body 12 and a humidity sensor 32 for detecting humidity of the inside of the image formation apparatus body 12 are provided over the paper feeding cassette 24.

A transport path 34 is a paper path extending from the feed roll 26 to a delivery outlet 36, and this transport path 34 is located in the vicinity of the back side (right side of FIG. 2) of the image formation apparatus body 12 and is formed substantially perpendicularly from the paper feeding unit 20 to a fixing device 100 described below. A secondary transfer backup roll 82 and a secondary transfer roll 88 described below are arranged in the upstream side of the fixing device 100 of this transport path 34 and a resist roll 38 is arranged in the upstream side of the secondary transfer roll 88 and the secondary transfer backup roll 82. Also, a delivery roll 40 is arranged in the vicinity of the delivery outlet 36 of the transport path 34.

Therefore, paper fed from the paper feeding cassette 24 of the paper feeding unit 20 by the feed roll 26 is handled by the retard roll 28 and only the uppermost paper is guided to the transport path 34 and the paper is temporarily stopped by the resist roll 38 and is passed between the secondary transfer backup roll 82 and the secondary transfer roll 88 described below with timing and a toner image is transferred and this transferred toner image is fixed by the fixing device 100 and the paper is delivered from the delivery outlet 36 to a delivery part 42 provided in an upper portion of the opening and closing cover 16 by the delivery roll 40. This delivery part 42 is inclined so that a delivery outlet portion is low and becomes high gradually toward a front direction (left direction of FIG. 2).

In the image formation apparatus body 12, a developing device unit 44 such as a rotary development device is arranged in the substantially center. The developing device unit 44 has a developing device unit body 46 and four developing devices 48a to 48d for forming a toner image are attached to this developing device unit body 46. These developing devices 48a to 48d rotate around a rotating shaft 50 together with the developing device unit body 46 in a direction of left-hand rotation (counterclockwise in FIG. 2). Tubular toner cartridges 52a to 52d for accommodating toners of yellow (Yellow: Y), magenta (Magenta: M), cyan (Cyan: C) and black (Black: K) are respectively attached to the developing devices 48a to 48d. When the toner cartridges 52a to 52d are attached to the developing device unit body 46 through the developing devices 48a to 48d, the toner cartridges are constructed so that the outside substantially matches with the outer circumference of the developing device unit body 46.

In the developing device unit 44, an image carrier 54 made of, for example, a photoconductor is arranged so as to abut from the rear side (right side in FIG. 2) of the image formation apparatus 10. In other words, in the developing device unit 44, four colors of Y, M, C and K are prepared for full color development and the developing devices 48a to 48d are rotationally moved and positioned in a position opposed to the image carrier 54, respectively and a latent image on the image carrier 54 is sequentially developed by the toners of yellow (Y), magenta (M), cyan (C) and black (K) one by one.

Also, a wireless communication part 56 is arranged in the vicinity of a position substantially opposed to the image carrier 54 with the rotating shaft 50 of the developing device unit 44 interposed. The wireless communication part 56 has an antenna 58 and conducts wireless communication with a memory chip 170 described below.

An electrification device 60 made of, for example, an electrification roll for uniformly electrifying this image carrier 54 is provided under the image carrier 54. Also, a cleaner 62 for image carrier abuts on the upstream side from the electrification device 60 of a rotation direction of the image carrier 54. The cleaner 62 for image carrier comprises, for example, a cleaning blade 64 for scraping the toner remaining on the image carrier 54 after primary transfer, and a waste toner recovery bottle 66 for recovering the toner scraped by the cleaning blade 64.

Incidentally, the rear side (right side in FIG. 2) of the waste toner recovery bottle 66 forms a portion of the transport path 34 by forming, for example, a rib etc. and being curved so as to smoothly transport the paper.

A light exposure device 68 for writing a latent image by a light beam such as laser light with respect to the image carrier 54 electrified by the electrification device 60 is arranged under the rear side of the developing device unit 44. Also, an unused detection sensor 70 such as a reflective type photo-sensor for detecting whether the toner cartridges 52a to 52d attached to the developing device unit 44 are unused or not is arranged over the developing device unit 44. An intermediate transfer device 72 for collectively transferring the toner image to the paper in a secondary transfer position described below after superimposing the toner image of four colors on an intermediate transfer body 74 by primarily transferring the toner image visualized by the developing device unit 44 by one color in a primary transfer position every one turn of the intermediate transfer body 74 is provided over the developing device unit 44 and the unused detection sensor 70.

The intermediate transfer device 72 comprises, for example, the intermediate transfer body 74 such as an intermediate transfer belt, a primary transfer roll 76, a wrap-in roll 78, a wrap-out roll 80, a secondary transfer backup roll 82, a scraper backup roll 84 and a brush backup roll 86. The intermediate transfer body 74 has, for example, elasticity and is stretched in a substantially flat state so as to have long sides and short sides over the developing device unit 44. The long side of the upper surface side of the intermediate transfer body 74 is stretched, for example, so as to be substantially parallel to the delivery part 42 provided in an upper portion of the image formation apparatus body 12. Also, the intermediate transfer body 74 has a primary transfer part (image carrier wrap region) for abutting on the image carrier 54 in a wrap state between the wrap-out roll 80 arranged in a downstream portion of the primary transfer roll 76 and the wrap-in roll 78 arranged in an upstream portion of the primary transfer roll 76 in the long side of the lower surface side, and is wrapped around the image carrier 54 in only a predetermined range and follows rotation of the image carrier 54.

Further, in the back side (right side of FIG. 2) of the intermediate transfer body 74, a flat part (short side) is formed by the wrap-out roll 80 and the secondary transfer backup roll 82 and this flat part is constructed so as to form a secondary transfer part and face the transport path 34.

Thus, in the intermediate transfer body 74, the toner image on the image carrier 54 is primarily transferred by superimposing the toner image in order of, for example, yellow, magenta, cyan and black by the primary transfer roll 76 and this toner image primarily transferred is transported toward the secondary transfer part.

The scraper backup roll 84 helps a scraper 94 described below to scrape the toner remaining on the intermediate transfer body 74 after secondary transfer, and the brush backup roll 86 helps a brush roll 96 described below to scrape the toner remaining on the intermediate transfer body 74 after secondary transfer.

A secondary transfer roll 88 faces the secondary transfer backup roll 82 of the intermediate transfer device 72 with the transport path 34 interposed. In other words, a secondary transfer position in the secondary transfer part is formed between the secondary transfer roll 88 and the secondary transfer backup roll 82, and the secondary transfer roll 88 secondarily transfers the toner image primarily transferred to the intermediate transfer body 74 to the paper in the secondary transfer position by help of the secondary transfer backup roll 82. In this case, the secondary transfer roll 88 is constructed so as to be separate from the intermediate transfer body 74 while the intermediate transfer body 74 makes three turns, that is, while the toner image of three colors of yellow, magenta and cyan is transported and abut on the intermediate transfer body 74 when the toner image of black is transferred. Incidentally, it is constructed so that a predetermined potential difference is generated between the secondary transfer roll 88 and the secondary transfer backup roll 82 and, for example, when the secondary transfer roll 88 is set at high voltage, the secondary transfer backup roll 82 is connected to ground (GND) etc.

In the upstream side of the secondary transfer position, an image density sensor 90 such as a reflective type photo-sensor is disposed so as to be opposed to the intermediate transfer body 74 with the transport path 34 interposed. The image density sensor 90 reads a patch of toner formed on the intermediate transfer body 74 and detects a density of an image formed on the intermediate transfer body 74.

A cleaner 92 for intermediate transfer body is provided so as to abut on the end of the intermediate transfer body 74 opposite to the image carrier. The cleaner 92 for intermediate transfer body comprises, for example, a scraper 94 for doing cleaning by scraping the toner remaining on the intermediate transfer body 74 after secondary transfer, a brush roll 96 for further scraping the toner remaining after the cleaning by the scraper 94, and a waste toner recovery bottle 98 for recovering the toner scraped by the scraper 94 and the brush roll 96. The scraper 94 is made of, for example, a stainless thin plate and a voltage of polarity opposite to that of the toner is applied. The brush roll 96 is made of, for example, a brush of acrylic etc. in which conductive treatment is performed. Also, the scraper 94 and the brush roll 96 are constructed so as to be separate from the intermediate transfer body 74 while intermediate transfer body 74 transports the toner image and combine to abut on the intermediate transfer body 74 at predetermined timing.

The fixing device 100 is arranged over the secondary transfer position. The fixing device 100 has a heating roll 102 and a pressurizing roll 104, and the toner image secondarily transferred to the paper by the secondary transfer roll 88 and the secondary transfer backup roll 82 is fixed to the paper and is transported toward the delivery roll 40.

Also, a control part 106 for controlling each part forming the image formation apparatus 10 is disposed inside the image formation apparatus body 12.

An image carrier unit 108 is unit obtained by integrating the image carrier 54, the electrification device 60 and the cleaner 62 for image carrier. Further, an image formation unit 110 is unit obtained by integrating the image carrier unit 108, the intermediate transfer device 72 and the cleaner 92 for intermediate transfer body. Also, a fixing unit 112 is unit obtained by integrating the fixing device 100 and the delivery roll 40.

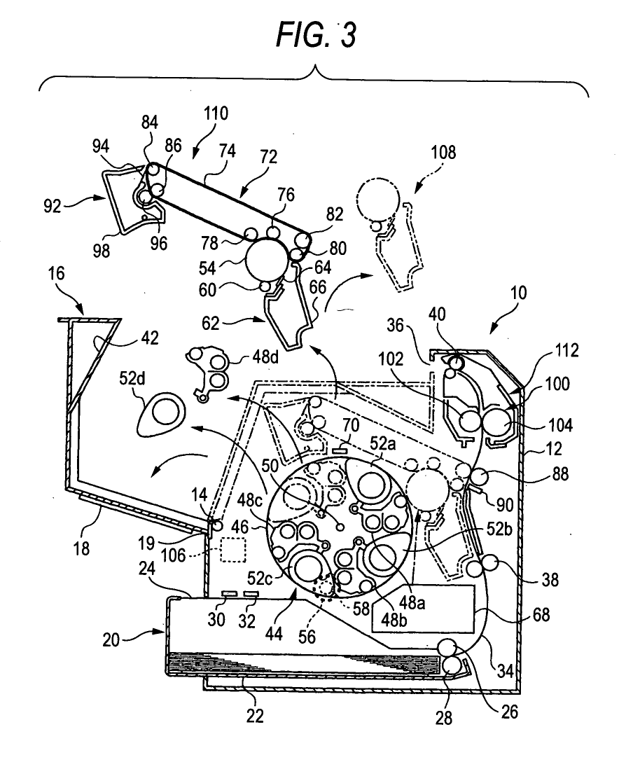

Also as shown in FIG. 3, the image formation unit 110 can be attached to and detached from the image formation apparatus body 12, and is attached and detached by opening the opening and closing cover 16. Also, the image carrier unit 108 can be attached to and detached from the image formation unit 110.

The toner cartridges 52a to 52d are constructed so as to be attached to and detached from the developing devices 48a to 48d attached to the developing device unit body 46 in the case of opening the opening and closing cover 16 and being located in the front side (side of the opening and closing cover 16). The developing devices 48a to 48d are constructed so as to be attached to and detached from the developing device unit body 46 in the case of opening the opening and closing cover 16 and being located in the front side (side of the opening and closing cover 16).

The fixing unit 112 is constructed so as to be attached to and detached from the image formation apparatus body 12 by removing an upper cover (not shown). Also, other units such as the developing device unit 44 and the paper feeding unit 20 can be attached to and detached from the image formation apparatus body 12.

Thus, each the unit can be replaced by a user. On the other hand, in the case that a user attaches a replaceable unit to the image formation apparatus 10, troubles in which good image quality cannot be maintained or an operation cannot be guaranteed, etc. may occur when a product other than a genuine product is attached to the image formation apparatus 10. This is because the image formation apparatus 10 is controlled according to characteristics etc. of a member used in the image formation apparatus 10. Hence, the unit which the user can replace is provided with a sensor etc. for detecting a predetermined condition.

When any of the plural components such as the developing devices 48a to 48d is shown without identification, any of the plural components may be abbreviated as simply “the developing device 48” below.

Next, an example of a replaceable unit having a sensor etc. for detecting a predetermined condition will be described.

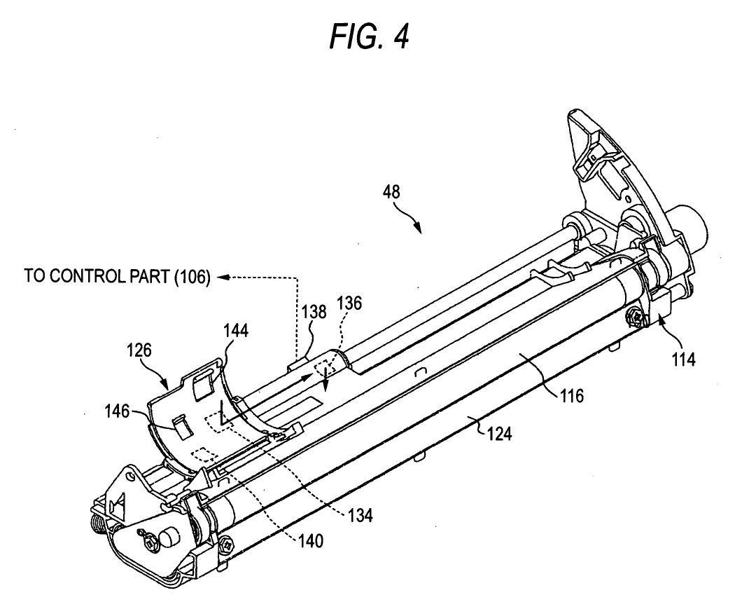

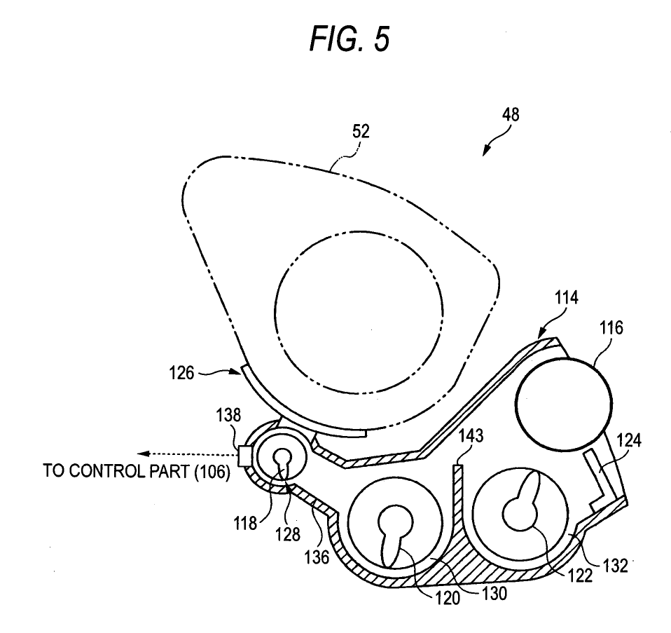

In FIGS. 4 and 5, a configuration of the developing device 48 which is a replaceable unit is shown.

The developing device 48 has a developing roll 116 acting as a developer carrier disposed in the side of the image carrier 54 of a developing device housing (developing device body) 114, a first auger 118, a second auger 120, a third auger 122 and a layer thickness regulating member 124, and accommodates a developer of a two-component system made of, for example, nonmagnetic toner and a magnetic carrier.

The developing device housing 114 has a shutter 126 for opening and closing a developer delivery outlet 140 and a toner receiving opening 134 described below, a tubular capture transport path 128 for transporting toner captured from the toner cartridge 52, and tubular developer transport paths 130, 132 for stirring and transporting toner and a carrier.

The capture transport path 128 has the toner receiving opening 134 for receiving toner from the toner cartridge 52 and a toner feeding opening 136 for feeding toner to the developer transport path 130, and the first auger 118 is disposed inside the capture transport path 128. The first auger 118 transports the toner received from the toner cartridge 52 by the capture transport path 128 to the developer transport path 130. Also, it is constructed so that the amount of toner supplied from the toner cartridge 52 to the developing device 48 is adjusted by adjusting rotation of the first auger 118. Therefore, it may be constructed so that a CPU 202 described below accumulates the number of rotations or driving time of the first auger 118, thereby calculating the amount of use of toner (the amount of use of the toner cartridge 52). Also, a current flowing at the time when the light exposure device 68 writes an electrostatic latent image into the image carrier 54 is accumulated in a capacitor etc. as an electric charge and the CPU 202 counts the number of times in which the accumulated electric charge reaches a predetermined amount and thereby the amount of use of toner may be calculated.

The capture transport path 128 is provided with a toner presence detection sensor 138 between the toner receiving opening 134 and the toner feeding opening 136, and this toner presence detection sensor 138 detects the presence or absence of toner of the inside of the capture transport path 128 by, for example, detecting a change in a resistance value by the presence or absence of toner between two points of the inside of the capture transport path 128.

The developer transport path 130 has the developer delivery outlet 140 for delivering a surplus developer to the toner cartridge 52, and the second auger 120 is disposed inside the developer transport path 130. The second auger 120 stirs and mixes a carrier and toner transported through the capture transport path 128, and transports them to the developer transport path 132.

The third auger 122 is disposed inside the developer transport path 132. The third auger 122 stirs and transports the developer transported through the developer transport path 130, and supplies the developer to the developing roll 116.

Incidentally, a partition plate 143 is provided between the developer transport path 130 and the developer transport path 132, and a passage (not shown) for making connection between the developer transport path 130 and the developer transport path 132 is provided in both ends of the partition plate 143. Therefore, it is constructed so that the second auger 120 and the third auger 122 transport the developer in an alternate direction and thereby toner is frictionally electrified to the amount of electrification of predetermined polarity by a carrier and is circulated inside the developing device housing 114. Also, it is constructed so that the total life of the developer increases by delivering the deteriorated developer from the developer delivery outlet 140 to the toner cartridge 52 at predetermined timing (trickle developing method).

The shutter 126 has openings 144, 146, and a passage of toner from the toner cartridge 52 to the developing device 48 is formed by overlaying the opening 144 with the toner receiving opening 134 and a passage of a surplus developer from the developing device 48 to the toner cartridge 52 is formed by overlaying the opening 146 with the developer delivery outlet 140.

The developing roll 116 develops an electrostatic latent image carried in the image carrier 54 with toner by carrying the toner and abutting on the image carrier 54. The layer thickness regulating member 124 regulates a layer thickness carried in the developing roll 116.

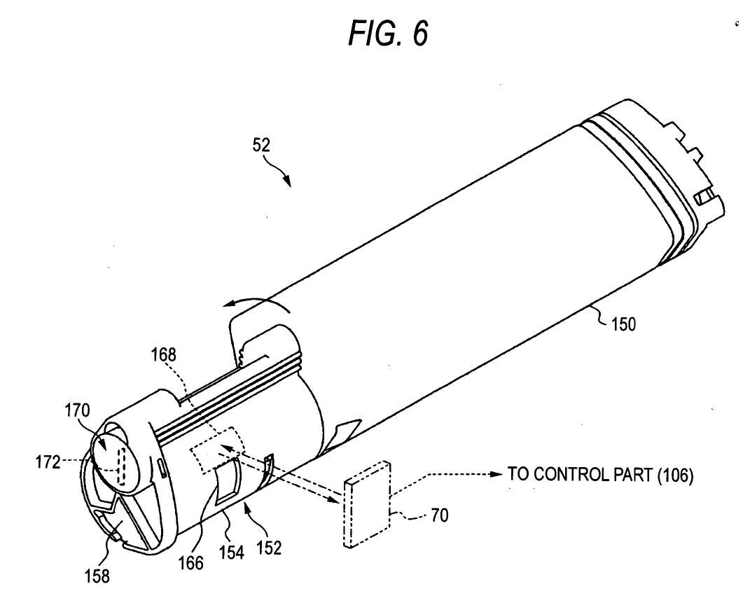

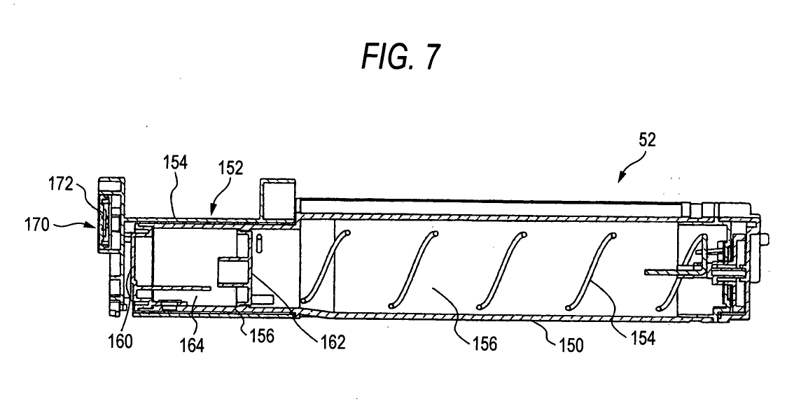

In FIGS. 6 and 7, a configuration of the toner cartridge 52 which is a replaceable unit is shown.

The toner cartridge 52 has a toner cartridge body 150 and a rotation part 152 provided in one end of a longitudinal direction of this toner cartridge body 150.

The toner cartridge body 150 is formed in tubular shape and is formed so that a substantially cylindrical portion in which a stir transport member 154 is arranged in the inside and a gradually narrowed portion extending in a direction substantially perpendicular to a longitudinal direction from this substantially cylindrical portion are integrated. Also, the toner cartridge body 150 is constructed so that the outside substantially matches with the outer circumference of the developing device unit body 46 when the toner cartridge 52 is attached to the developing device unit body 46 through the developing device 48.

Toner accommodation space 156 for accommodating toner supplied to the developing device 48 is formed inside the toner cartridge body 150. The toner accommodation space 156 is provided with the stir transport member 154 described above. This stir transport member 154 is wound, for example, in spiral shape and stirs toner of the inside of the toner accommodation space 156 and transports the toner toward the toner receiving opening 134 of the developing device 48.

The rotation part 152 has a rotation part body 154 and a cylindrical tube part 156 which is provided inside this rotation part body 154 and is formed integrally with the toner cartridge body 150. In the tube part 156, the side of a side surface 158 of the rotation part body 154 is sealed by a tube part sidewall 160 and a separation wall 162 is provided in the inside. Developer recovery space 164 for recovering a surplus developer from the developing device 48 is formed in the side of the tube part sidewall 160 of the separation wall 162, and the toner accommodation space 156 described above extends and is formed in the side opposite to the tube part sidewall 160 of the separation wall 162.

The rotation part body 154 has a window-like window part 166 covered with a transparent member and the inside is formed in cylindrical shape and it is constructed so as to rotate along the outside of a cylindrical portion of the tube part 156. Also, a reflective member 168 such as white tape is mounted to the outside of the cylindrical portion of the tube part 156 and the toner cartridge 52 is attached to the developing device 48 and the reflective member 168 is constructed so as to be exposed through the window part 166 when the rotation part body 154 rotates. Also, when the developing device unit 44 to which the toner cartridge 52 is attached rotates inside the image formation apparatus body 12, the exposed reflective member 168 is constructed so as to pass through a position opposed to the unused detection sensor 70 fastened to the image formation apparatus body 12. As described above, the unused detection sensor 70 is, for example, a reflective type photo-sensor and when the reflective member 168 of the toner cartridge 52 attached to the developing device unit 44 passes through the position opposed to the unused detection sensor 70, the reflective member 168 detects the amount of reflection changing depending on dirt due to the toner, thereby detecting whether the toner cartridge 52 is unused or not.

A memory chip 170 is mounted to the side surface 158 of the rotation part body 154. The memory chip 170 has an antenna 172 and conducts wireless communication with the wireless communication part 56 provided in the side of the image formation apparatus body 12.

Next, with the wireless communication part 56 and the memory chip 170, respective circuit configurations and communication conducted between the mutual part and chip will be described.

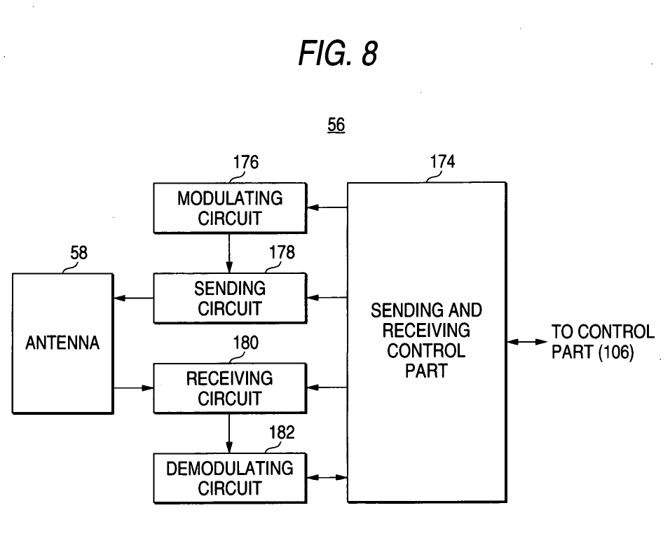

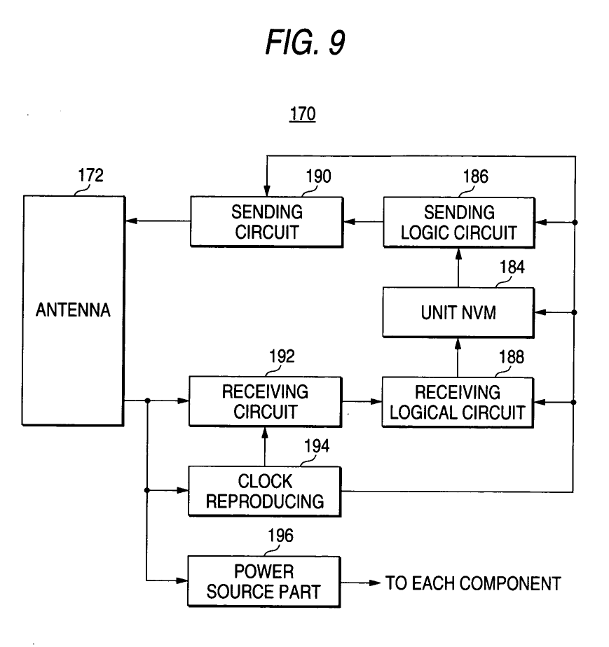

FIG. 8 is a block diagram showing a circuit configuration of the wireless communication part 56. FIG. 9 is a block diagram showing a circuit configuration of the memory chip 170.

As shown in FIG. 8, a circuit of the wireless communication part 56 comprises a sending and receiving control part 174, a modulating circuit 176, a sending circuit 178, a receiving circuit 180, a demodulating circuit 182 and an antenna 58. In the wireless communication part 56, the sending and receiving control part 174 controls an action of each component of the wireless communication part 56. Then, the sending and receiving control part 174 outputs data inputted from the control part 106 to the modulating circuit 176. Also, the sending and receiving control part 174 outputs data which is received by the receiving circuit 180 and is demodulated by the demodulating circuit 182 to the control part 106. The modulating circuit 176 modulates data inputted from the sending and receiving control part 174 and outputs the data to the sending circuit 178. The sending circuit 178 outputs a radio wave signal including a clock signal etc. and data stored in the memory chip 170 to the memory chip 170 through the antenna 58.

The receiving circuit 180 receives a signal sent from the memory chip 170 through the antenna 58 and outputs the signal to the demodulating circuit 182. The demodulating circuit 182 demodulates data sent by the memory chip 170 from a change in a signal inputted from the receiving circuit 180 and outputs the data to the sending and receiving control part 174.

As shown in FIG. 9, a circuit of the memory chip 170 comprises a unit NVM (Non Volatile Memory) 184, a sending logical circuit 186, a receiving logical circuit 188, a sending circuit 190, a receiving circuit 192, a clock reproducing circuit 194, a power source part 196 and an antenna 172.

When a radio wave signal is sent from the wireless communication part 56 to the memory chip 170, the receiving circuit 192, the clock reproducing circuit 194 and the power source part 196 receive this radio wave signal through the antenna 172. In the memory chip 170, when the power source part 196 receives the radio wave signal, a current generated by electromagnetic induction through the radio wave signal is rectified and electric power necessary for their actions is supplied to each of the components of the memory chip 170. The memory chip 170 may be configured so as to receive supply of electric power from a body part 40, for example, when a voltage higher than a voltage generated by the power source part 196 is required. For example, the electric power may be supplied from an AC supplied to the developing device unit 44 with noncontact by further providing a coil etc. for power source in the memory chip 170.

When the clock reproducing circuit 194 receives the radio wave signal, a clock signal is reproduced and is outputted to each the circuit forming the memory chip 170. When the receiving circuit 192 receives the radio wave signal, a signal such as data included in the radio wave signal is synchronized with the clock signal inputted from the clock reproducing circuit 194 and is outputted to the receiving logical circuit 188. The receiving logical circuit 188 synchronizes a signal such as data inputted from the receiving circuit 192 with the clock signal inputted from the clock reproducing circuit 194 and demodulates the signal and outputs the signal to the unit NVM 184.

The unit NVM 184 is writable nonvolatile memory and when a signal inputted from the receiving logical circuit 188 in synchronization with the clock signal inputted from the clock reproducing circuit 194 indicates writing of data, the data is written (stored) and when the signal indicates readout of data, data stored in the unit NVM 184 is outputted to the sending logical circuit 186. The nonvolatile memory included in the unit NVM 184 may be, for example, flash ROM, EEPROM or FeRAM (ferroelectric memory), etc.

The sending logical circuit 186 modulates data inputted from the unit NVM 184 in synchronization with the clock signal inputted from the clock reproducing circuit 194 and outputs the data to the sending circuit 190. The sending circuit 190 sends a signal inputted from the sending logical circuit 186 in synchronization with the clock signal inputted from the clock reproducing circuit 194 to the wireless communication part 56 through the antenna 172 as a radio wave signal.

Incidentally, a signal sent and received as the radio wave signal may be constructed so as to be sent and received by being converted into the radio wave signal after being encrypted. Also, it may be constructed so that, for example, an authorized user etc. can rewrite the contents of the unit NVM 184 from a device other than the control part 106 using the encrypted radio wave signal.

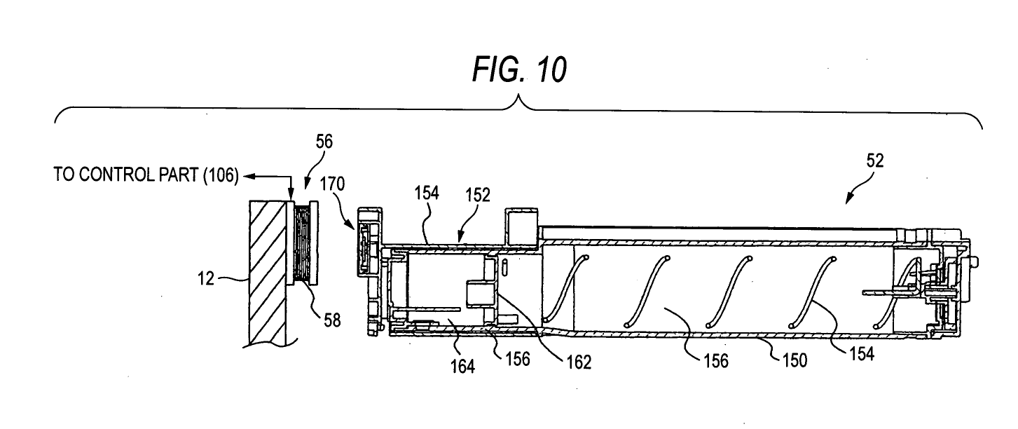

In FIG. 10, a position relation between the memory chip 170 and the wireless communication part 56 for conducting wireless communication is shown. As described above, the toner cartridges 52 are respectively attached to the developing devices 48 and move by rotating the developing device unit 44 (FIG. 2) around the rotating shaft 50. The wireless communication part 56 is fastened to image formation apparatus body 12 in the vicinity of the side of the developing device unit 44 so that the memory chips 170 moving by rotation of the developing device unit 44 are substantially opposed sequentially and is constructed so as to conduct wireless communication in a stop state in which movement of the developing devices 48 is controlled in a position substantially opposed so as to be able to conduct wireless communication with any of the memory chips 170. Also, the wireless communication part 56 is constructed so as to check a start of sending and receiving of data, for example, by receiving an acknowledgment signal sent out by the memory chip 170 with respect to a radio wave signal outputted by the wireless communication part 56.

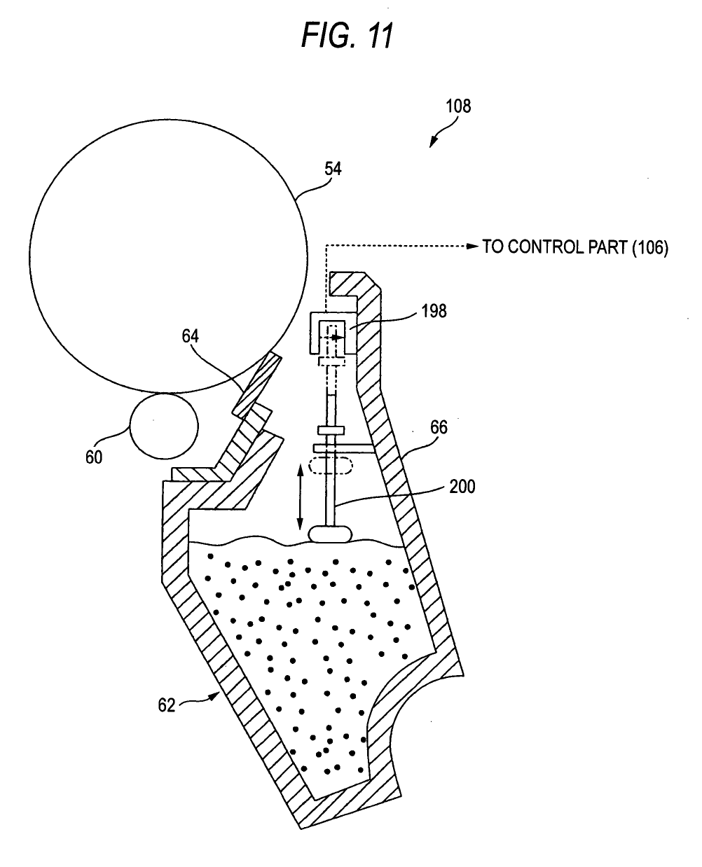

In FIG. 11, a configuration of the image carrier unit 108 which is a replaceable unit is shown.

As described above, the image carrier unit 108 is unit obtained by integrating the image carrier 54, the electrification device 60 and the cleaner 62 for image carrier, and has, for example, a waste toner full sensor 198 disposed in an upper portion inside the cleaner 62 for image carrier and a float 200 disposed under the waste toner full sensor 198. The waste toner full sensor 198 has an optical path constructed so that light emission of a light emitting part provided in one side is received by a light receiving part provided in the other side, and outputs a result as to whether the light receiving part has received or not to the control part 106. The float 200 is constructed so as to rise when waste toner recovered from the image carrier 54 into the waste toner recovery bottle 66 exceeds a predetermined amount, and is constructed so as to block the optical path of the waste toner full sensor 198 when the waste toner recovery bottle 66 becomes full of the waste toner. Thus, the image carrier unit 108 detects whether or not the waste toner recovery bottle 66 becomes full by the waste toner full sensor 198 and the float 200, and produces an output to the control part 106.

Also, it may be constructed so as to provide the waste toner full sensor 198 and the float 200 in the cleaner 92 for intermediate transfer body and detect whether or not the waste toner recovery bottle 98 becomes full.

Thus, it is constructed so that a replaceable unit having a sensor etc. for detecting a predetermined condition outputs a result detected by the sensor etc. to the control part 106 and the control part 106 controls each the part forming the image formation apparatus 10 based on the detected result inputted.

Next, a configuration of the control part 106 will be described in detail.

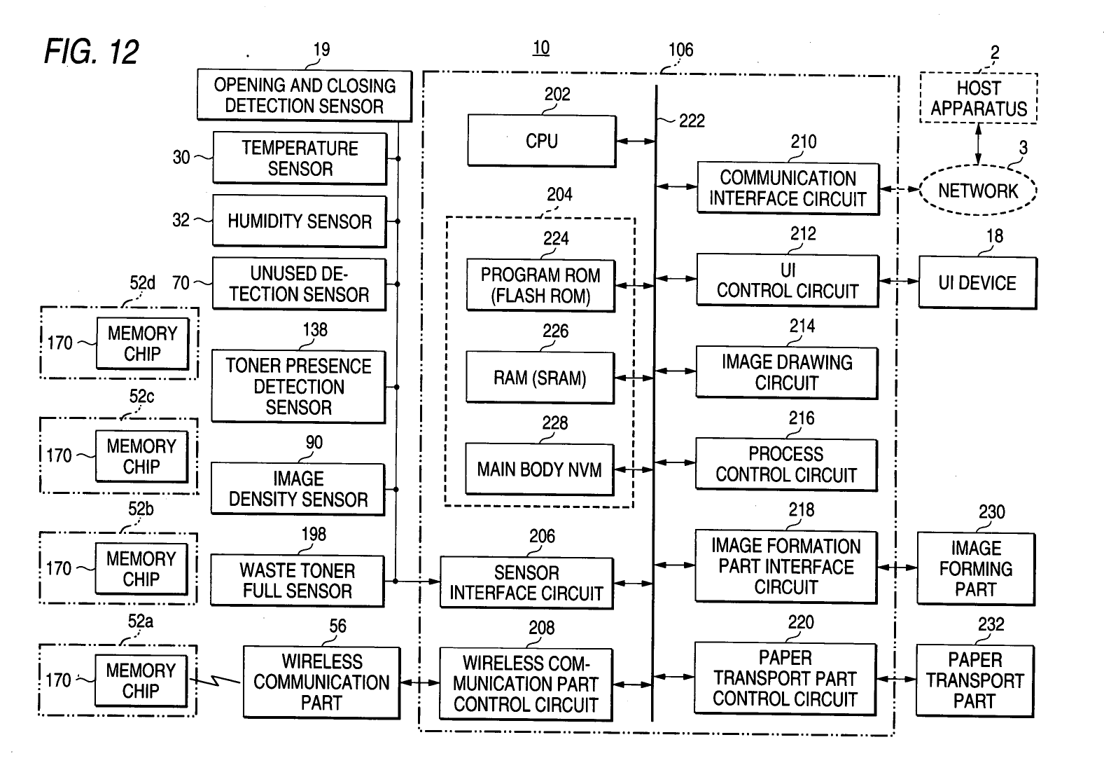

FIG. 12 is a block diagram showing a configuration of the control part 106 and each part connected to the control part 106.

The control part 106 has a CPU 202, a storage part 204, a sensor interface (sensor I/F) circuit 206, a wireless communication part control circuit 208, a communication interface (communication I/F) circuit 210, a user interface (UI) control circuit 212, an image drawing circuit 214, a process control circuit 216, an image formation part interface (image formation I/F) circuit 218 and a paper transport part control circuit 220, etc. and is configured so that these can input and output a signal through a system bus 222 mutually.

The CPU 202 sends and receives a signal between each of the parts forming the control part 106 through the system bus 222, and controls each of the parts forming the control part 106.

The storage part 204 has program ROM 224, RAM 226 and body NVM (Non Volatile Memory) 228, and stores information etc. necessary for control of the image formation apparatus 10. The program ROM 224 is made of, for example, flash ROM and may be constructed so as to update the contents of storage. The RAM 226 is made of, for example, SRAM and stores temporary information such as drawing data inputted from the image drawing circuit 214. The body NVM 228 is made of, for example, electrically rewritable nonvolatile memory such as EEPROM or flash ROM. Incidentally, the body NVM 228 may be optical memory or a HDD (Hard Disk Drive), SRAM in which a power source is backed up by a battery etc. as long as it is a rewritable storage device and data can be held even when a power source of the image formation apparatus 10 is turned off.

The sensor I/F circuit 206 receives detection results from each of the opening and closing detection sensor 19, the temperature sensor 30, the humidity sensor 32, the unused detection sensor 70, the toner presence detection sensor 138, the image density sensor 90 and the waste toner full sensor 198, and outputs the detection results to the CPU 202 through the system bus 222. The wireless communication part control circuit 208 sends and receives a signal to and from four memory chips 170 provided in each of the toner cartridges 52a to 52d through the wireless communication part 56, and also sends and receives a signal to and from the CPU 202 and the storage part 204, etc. through the system bus 222, and connects each of the memory chips 170 to the CPU 202 and the storage part 204, etc.

The communication I/F circuit 210 sends and receives a signal to and from the host apparatus 2 through the network 3, and also sends and receives a signal to and from the CPU 202 etc. through the system bus 222, and connects the host apparatus 2 to the CPU 202 etc. The UI control circuit 212 sends and receives a signal to and from the UI device 18, and also sends and receives a signal to and from the CPU 202 etc. through the system bus 222, and connects the UI device 18 to the CPU 202 etc.

The image drawing circuit 214 draws an image based on an image formation signal inputted from the host apparatus 2 etc. and outputs the image to the CPU 202 and the RAM 226. The process control circuit 216 sees an under-mentioned setting value etc. stored in the storage part 204 along with the CPU 202, and controls an image formation part 230 including the light exposure device 68, the image formation unit 110 and the developing device unit 44, etc. through the image formation I/F circuit 218. The paper transport part control circuit 220 controls a paper transport part 232 including the feed roll 26, the retard roll 28 and the resist roll 38, etc. along with the CPU 202.

Incidentally, the CPU 202 can determine a state of the toner cartridge 52 to which the memory chip 170 is attached by comparing data stored in the storage part 204 with data stored in the unit NVM 184, so that the memory chip 170 forms a portion of a detection unit even without a sensor.

Next, details of data stored in the program ROM 224, the body NVM 228 and the unit NVM 184 will be described.

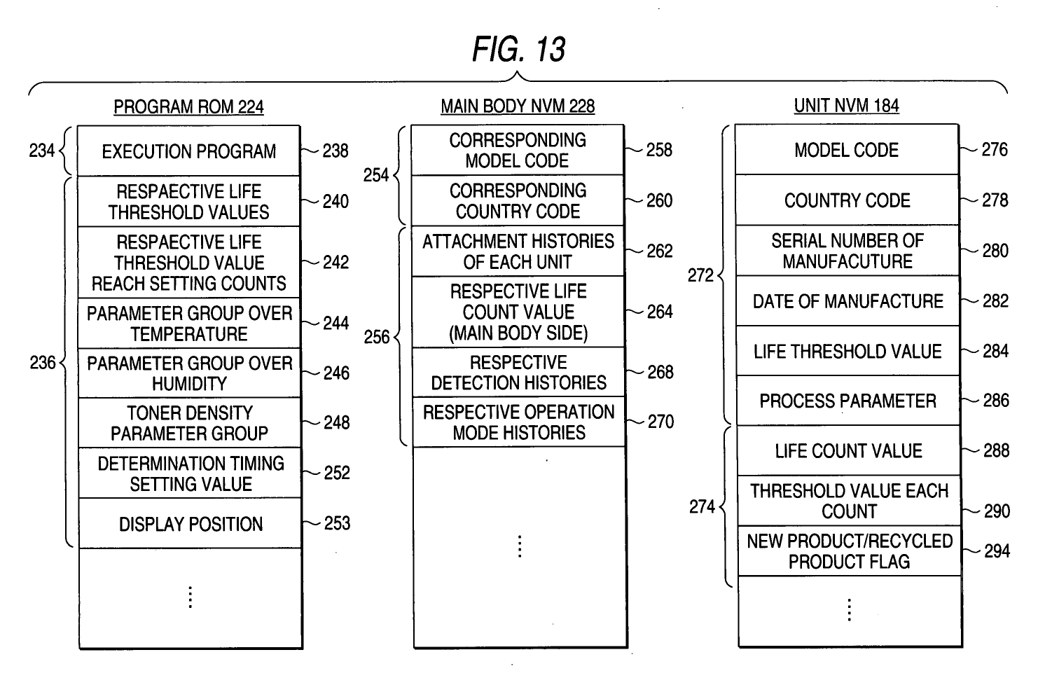

In FIG. 13, an example of data stored in the program ROM 224, the body NVM 228 and the unit NVM 184 is shown.

The program ROM 224 is provided with a program area 224 and a setting value area 236, etc. An execution program 238 for operating the image formation apparatus 10 is stored in the program area 224. Respective life threshold values 240, respective life threshold value reach setting counts 242, a parameter group 244 over temperature, a parameter group 246 over humidity, a toner density parameter group 248, a determination timing setting value 252, a display position 253, etc. are stored in the setting value area 236.

The respective life threshold values 240 include respective lives (life threshold values) of each of the replaceable units of the image formation apparatus 10. The respective life threshold value reach setting counts 242 include counts permitting each of the replaceable units of the image formation apparatus 10 to reach the life threshold values. The parameter group 244 over temperature includes each of the parameters about control over temperature of the image formation apparatus 10. The parameter group 246 over humidity includes each of the parameters about control over humidity of the image formation apparatus 10. The toner density parameter group 248 includes each of the parameters about control over a toner density of the inside of the developing device 48. The determination timing setting value 252 includes a period (determination timing) taken to start a determination as to whether to be a genuine product or a product other than the genuine product with respect to each of the replaceable units of the image formation apparatus 10 by the CPU 202 in processing etc. in which the image formation apparatus 10 makes printing preparations according to an operation mode.

The display position 253 includes a position in which display to the effect that a replaceable unit is a recycled product is performed when the replaceable unit is the recycled product as described below, for example, a predetermined position of the back of paper or a predetermined margin position of paper of a header, a footer, etc. of paper.

The body NVM 228 is provided with a corresponding unit information area 254 and a body side updating area 256, etc.

A corresponding model code 258 and a corresponding country code 260 are stored in the corresponding unit information area 254. The corresponding model code 258 stores a table (data) of models indicating that it is a model adapted for the image formation apparatus 10 with respect to each of the replaceable units of the image formation apparatus 10. The corresponding country code 260 stores a table (data) of each of the countries in which different specifications are set every country with respect to each of the replaceable units of the image formation apparatus 10.

Attachment histories 262 of each unit, respective life count values 264 of the body side, respective life threshold value reach counts 266 of the body side, respective detection histories 268 and respective operation mode histories 270, etc. are stored in the body side updating area 256. The attachment histories 262 of each unit include the respective attachment histories of each of the replaceable units of the image formation apparatus 10. Also, the fact that a genuine product is attached is stored in initial states (initial values) of the attachment histories 262 of each unit. The respective life count values 264 of the body side include the respective life count values (the amount of use to the present time since a start of use) of each of the replaceable units of the image formation apparatus 10. Incidentally, the amount of use of each unit may be calculated from the respective accumulated operating time etc. of each unit. The respective life threshold value reach counts 266 of the body side include the respective life threshold value reach counts of each of the replaceable units of the image formation apparatus 10. The respective detection histories 268 include histories of detection results detected by the respective sensors etc. provided in the image formation apparatus 10. The respective operation mode histories 270 include histories of operation modes respectively applied to each of the replaceable units of the image formation apparatus 10.

The unit NVM 184 is provided with a unit information area 272 and a unit side updating area 274, etc.

A model code 276 indicating a model, a country code 278 indicating a country in which specifications are set, a serial number 280 of manufacture specific to a unit, a date 282 of manufacture, a life threshold value 284 indicating a life of a unit and a process parameter 286 for process control, etc. are stored in the unit information area 272.

A life count value 288 indicating the amount of use to the present time since a start of use of the toner cartridge 52, a life threshold value reach count 290 indicating a count reaching a life threshold value stored in the life threshold value 284, related history information 292, flag information 294 for determining whether to be a new product or a recycled product, etc. are stored in the unit side updating area 274. Incidentally, the related history information 292 includes a history of available related information in order to grasp a state of the toner cartridge 52, for example, the number of rotations of the image carrier 54.

When an image formation signal is sent in the image formation apparatus 10 of the configuration described above, the image carrier 54 is uniformly electrified by the electrification device 60 and a light beam is emitted from the light exposure device 68 to this electrified image carrier 54 based on an image signal. The light beam from the light exposure device 68 exposes a surface of the image carrier 54 and a latent image is formed.

The latent image carried to the image carrier 54 is developed by the developing device unit 44 in a development position. In the developing device unit 44, toners of yellow, magenta, cyan and black are respectively supplied from the toner cartridges 52a to 52d to the developing devices 48a to 48d. Also, developers redundantly supplied to the developing devices 48a to 48d are respectively recovered to the toner cartridges 52a to 52d. By the developing devices 48a to 48d of the developing device unit 44, a toner image developed every color is superimposed on the intermediate transfer body 74 and is primarily transferred. In the primary transfer, the waste toner remaining on the image carrier 54 is scraped and recovered by the cleaner 62 for image carrier.

On the other hand, paper accommodated in the paper feeding cassette 24 by a paper feeding signal etc. is fed by the feed roll 26 and is handled by the retard roll 28 and is guided to the transport path 34 and is temporarily stopped by the resist roll 38 and is guided between the secondary transfer roll 88 and the secondary transfer backup roll 82 with timing. When the paper is guided between the secondary transfer roll 88 and the secondary transfer backup roll 82, a toner image superimposed on the intermediate transfer body 74 in four colors by primary transfer is secondarily transferred to thepaper by the secondary transfer roll 88 and the secondary transfer backup roll 82. After the secondary transfer, the waste toner remaining on the intermediate transfer body 74 is scraped and recovered by the cleaner 92 for intermediate transfer body.

The paper to which the toner image is transferred is guided to the fixing device 100 and the toner image is fixed by thermal pressure by the heating roll 102 and the pressurizing roll 104. The paper to which the toner image is fixed is delivered from the delivery outlet 36 to the delivery part 42 by the delivery roll 40. The control part 106 stores a life count value etc. of the toner cartridge 52 in the unit NVM 184 and the body NVM 228.

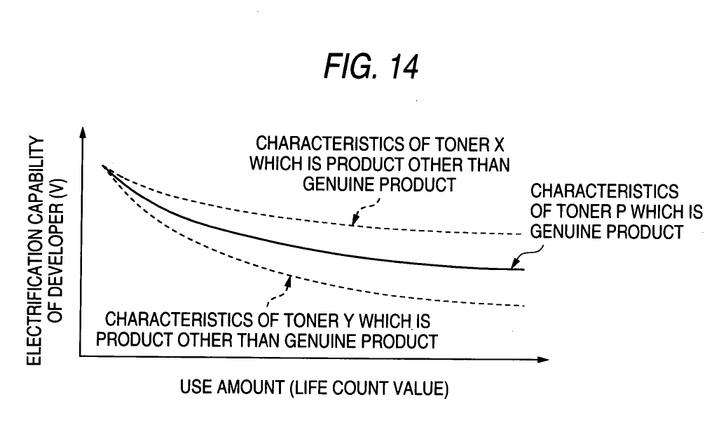

FIG. 14 is a graph showing a change in electrification capability of a developer versus a developer use amount (life count value) stored in the body NVM 228.

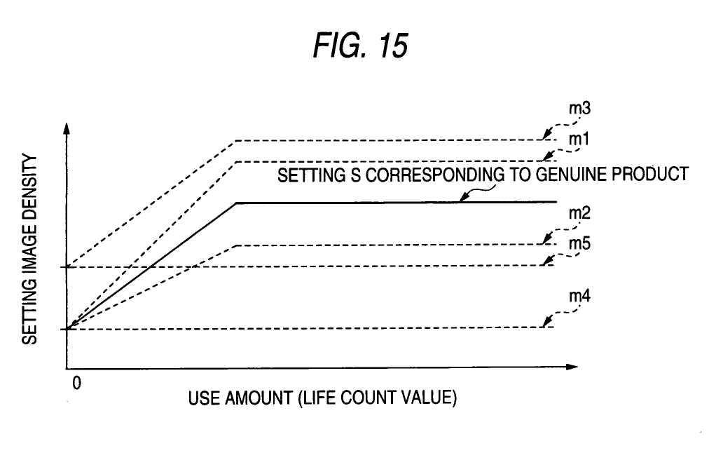

FIG. 15 is a graph showing setting for correcting a change in electrification capability of a developer and is a graph showing setting of an image density versus a developer use amount.

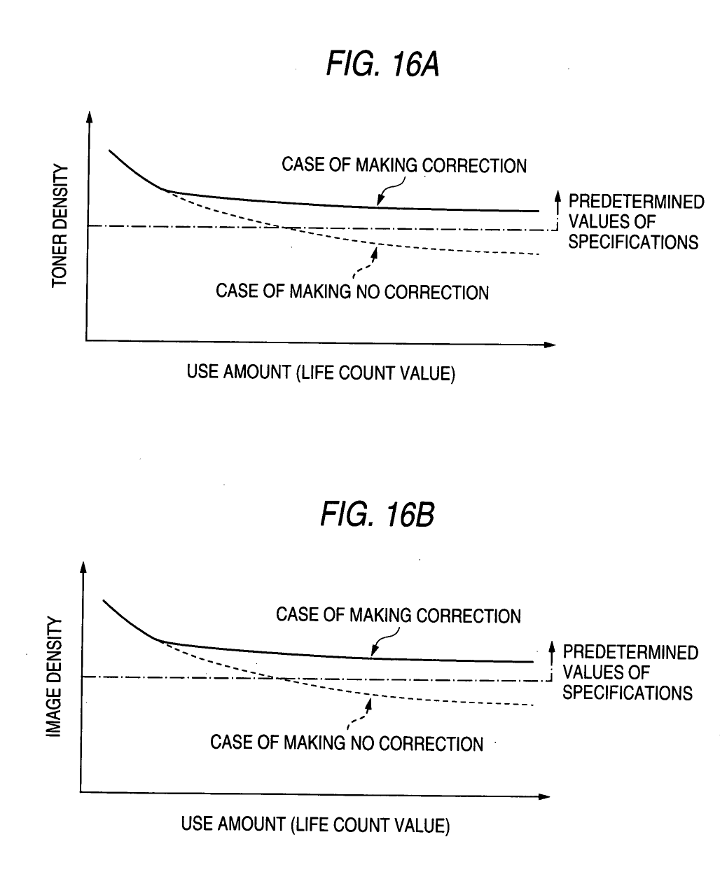

FIGS. 16A and 16B are graphs showing a result corrected by the setting shown in FIG. 15 and FIG. 16A is a graph showing a toner density corrected and FIG. 16B is a graph showing an image density corrected.

Toner accommodated in the toner cartridge 52 is frictionally electrified to the amount of electrification of predetermined polarity by a carrier inside the developing device 48. When a developer is used, electrification capability of the developer reduces according to the use amount of the developer as shown by characteristics of toner P which is a genuine product shown in FIG. 14.

Therefore, the image formation apparatus 10 is constructed so as to correct setting with respect to an image density on the intermediate transfer body 74 and a toner density inside the developing device 48 in order to maintain image quality of an image formed on paper at a predetermined level even when a trickle developing method is adopted.

For example, the CPU 202 detects an image density by the image density sensor 90 and when the density is high, rotation driving of the first auger 118 is controlled and the amount of toner supplied into the developing device 48 is decreased and a toner density is decreased and the image density is decreased. Also, when the density is low, rotation driving of the first auger 118 is controlled and the amount of toner supplied into the developing device 48 is increased and a toner density is increased and the image density is increased. Normally, a pattern having a half tone density is used in a pattern for the image density detection.

However, when electrification capability of toner reduces, development performance improves and an image density increases, so that when the control described above is performed as it is, a toner density is too decreased and the maximum image density decreases.

Hence, a setting value of control of a toner density inside the developing device 48 stored in the toner density parameter group 248 used in toner density control based on an image density detection result by the image density sensor 90 is corrected so as to be increased according to the use amount of a developer so that a density of the maximum image transferred to paper does not decrease even when electrification capability of the developer reduces. The CPU 202 maintains a toner density so that the toner density does not decrease to a desired predetermined value or less as shown in FIG. 16A by rotating the first auger 118 according to the corrected setting value (FIG. 15: setting S corresponding to toner P).

As a result of that, an image density can be maintained so that the image density does not decrease to a predetermined value or less of specifications as shown in FIG. 16B.

On the other hand, in the case of attaching a toner cartridge which is a product other than a genuine product and has the substantially same configuration as that of the toner cartridge 52 in which toner X or toner Y which is a product other than a genuine product with respect to the image formation apparatus 10 is accommodated, it is expected to indicate characteristics different from those of the toner P which is a genuine product as shown in FIG. 14. Therefore, a corrected setting value different from the setting S corresponding to the toner P is required in order to improve image quality of an image formed on paper. Hence, for example, in the case of a product, in which the toner X or toner Y is accommodated, other than a genuine product, correction to the use amount of a developer is changed in combinations of change conditions that the amount of change (inclination) in a setting value of a toner density is increased or decreased (m1, m2: FIG. 15), a limit value is increased or decreased (m1, m2), an initial value (use amount=0) is changed (m3), a change in a setting value according to the use amount is not made (m4) and, for example, an initial value is changed and a change in a setting value according to the use amount is not made (m5), etc. This change is made by being set in an operation mode different from an operation mode corresponding to a genuine product and making a selection through the UI device 18 by a user.

Next, control of the image formation apparatus 10 based on data stored in the storage part 204 and the unit NVM 184 will be described.

The image formation apparatus 10 controls display etc. by the UI device 18 based on data stored in the storage part 204 and the unit NVM 184. For example, by control of the CPU 202, the UI device 18 displays the remaining amount of toner when the toner cartridge 52 is a genuine product, and displays the use amount of toner when the toner cartridge 52 is a product other than the genuine product. This is because the remaining amount of toner cannot be calculated since the amount of toner is unknown when it is the product other than the genuine product.

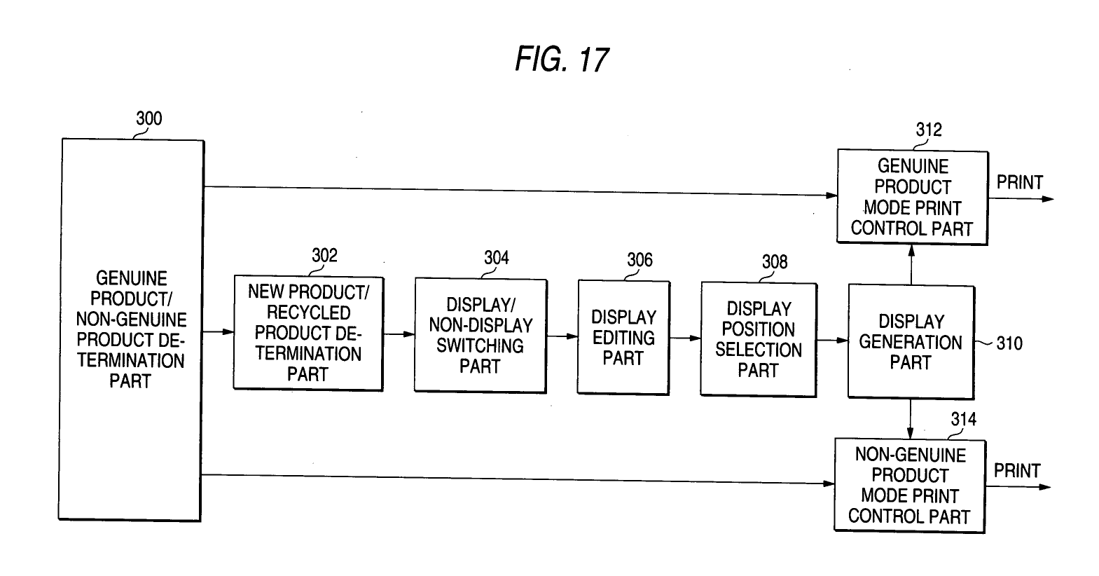

FIG. 17 is a block diagram showing a portion of a software configuration stored in the program ROM 224 as the execution program 238. The execution program 238 has a genuine product/non-genuine product determination part 300 for determining whether a replacement unit is a genuine product or a product other than the genuine product. It is determined whether a replacement unit is a genuine product or a product other than the genuine product, for example, based on one or plural information among the following (1) to (5).

(1) User Input Information

In the case of being able to do input as to whether a replacement unit is a genuine product or a product other than the genuine product from the user interface 18 of the image formation apparatus 10 or the host apparatus 2 described above, determination is made based on its input information.

(2) Presence or Absence of Memory Chip

A genuine product includes the memory chip 170, but there are cases where the memory chip 170 is not mounted in a product other than the genuine product. Hence, it is determined that it is a product other than the genuine product when there is no response from the replacement unit side even in the case of making a response request from the wireless communication part 56.

(3) Code Information

It is determined whether or not there is identity by comparing the model code 276, the country code 278, etc. of the unit NVM 184 with the corresponding model code 258, the corresponding country code 260, etc. of the body NVM 228. In this determination, an allowable range (the case that the model code is similar, the case that the country code is similar, etc.) can be provided in the range having identity as well as the case that each is perfectly identical.

(4) Use Amount

It can be determined that it is a product other than the genuine product when a life count value of the memory chip 170 exceeds, for example, the life threshold value 240 of the program ROM 224.

(5) Detection of Control State

As described above, a genuine product may differ from a product other than the genuine product in electrification characteristics of toner according to the use amount. Hence, it can be determined that a product other than the genuine product is attached when a toner density does not reach a predetermined value even in the case of making a predetermined correction.

Also, the execution program 238 has a new product/recycled product determination part 302 for determining whether a replacement unit is a new product or a recycled product. It is determined whether a replacement unit is a new product or a recycled product, for example, based on one or plural information among the following (1) to (4).

(1) User Input Information

In the case of being able to do input as to whether a replacement unit is a new product or a recycled product from the user interface 18 of the image formation apparatus 10 or the host apparatus 2 described above, determination is made based on its input information.

(2) Use Amount

It can be determined that it is a recycled product when the life count value 288 of the memory chip 170 exceeds, for example, the life threshold value 240 of the program ROM 224.

(3) Flag

It can be determined whether it is a new product or a recycled product according to a new product/recycled product flag 290 of the memory chip 170. For a genuine product, the life count value 288 of the memory chip 170 is reset at the time of recycling, so that determination is made based on this flag.

(4) Output of Unused Sensor 70

Because the reflective member 168 is not dirty with toner when a replacement unit of a new product is attached, the unused sensor 70 can detect that the new product is attached.

Also, the execution program 238 has a display/non-display switching part 304. This display/non-display switching part 304 switches between non-display and display to the effect that a recycled product is used based on information selected and inputted by a user through the user interface 18 of the image formation apparatus 10 or the host apparatus 2 described above.

Also, the execution program 238 has a display editing part 306. This display editing part 306 edits a form of display to the effect that a recycled product is used based on editing information inputted by a user through the user interface 18 of the image formation apparatus 10 or the host apparatus 2. For example, in a default, a text in which “the present system prints by environmentally friendly recycled toner” can be edited or displayed in a display image. Also, black and white display, color display or watermark (hidden display) can also be performed.

Also, the execution program 238 has a display position selection part 308. This display position selection part 308 selects a predetermined position of the back of paper or a predetermined margin position of paper of a header, a footer, etc. stored in the display position 253 described above based on information selected and inputted by a user through the user interface 18 of the image formation apparatus 10 or the host apparatus 2.

Also, the execution program 238 has a display generation part 310 for generating an image of display to the effect that a recycled product is used. An image generated by the display generation part 310 is combined with an input image or is singly expanded into a bitmap by the image drawing circuit 214 and is printed on paper.

Also, the execution program 238 has a genuine product mode print control part 312 for performing print control in a genuine product mode which is an operation mode of the case of attaching a genuine product unit as a replacement unit and a non-genuine product mode print control part 314 for performing print control in a non-genuine product mode which is an operation mode of the case of attaching a non-genuine product unit. The genuine product mode print control part 312 and the non-genuine product mode print control part 314 respectively perform control suitable for a genuine product and control suitable for a non-genuine product as described in FIGS. 14 to 16.

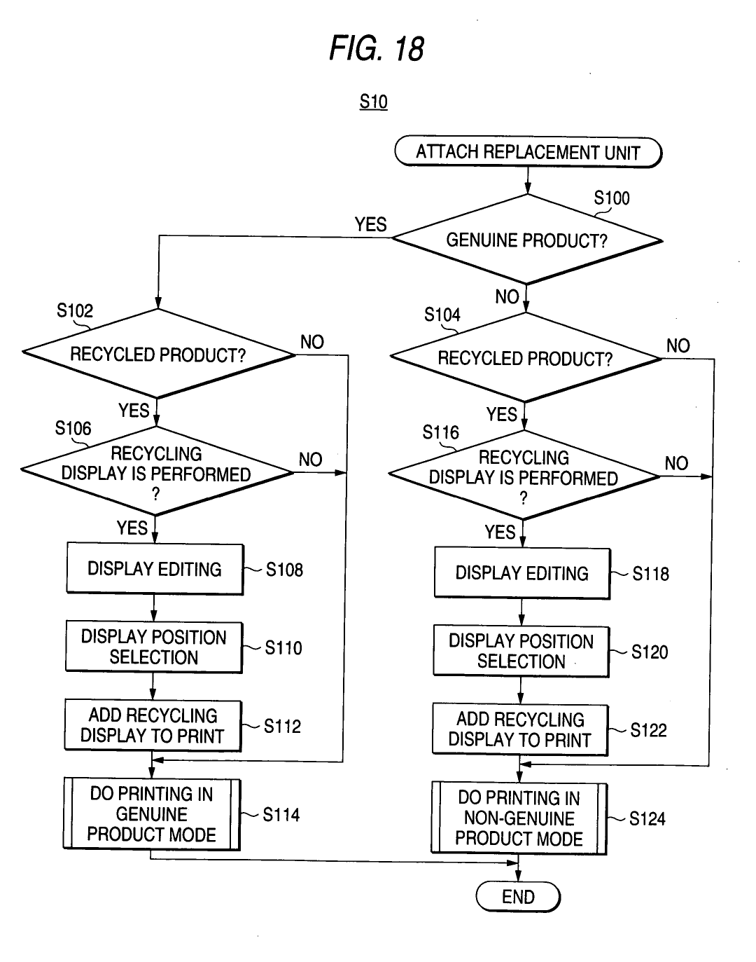

FIG. 18 is a flowchart (S10) showing a control flow of the case of attaching a replacement unit.

When a replacement unit is attached, it is first determined whether the replacement unit is a genuine product or a product other than the genuine product in step 100 (S100). When it is determined that the replacement unit is the genuine product, the flowchart proceeds to the next step 102 (S102) and it is determined whether it is a recycled product or not. On the other hand, when it is determined that the replacement unit is the product other than the genuine product, the flowchart proceeds to the next step 104 (S104) and it is similarly determined whether it is a recycled product or not. When it is determined that it is not the recycled product by step 102 (S102), step 106 (S106), step 108 (S108), step 110 (S110) and step 112 (S112) are jumped and the flowchart proceeds to step 114 (S114) and printing is done in the genuine product mode described above and the processing is ended. On the other hand, when it is determined that it is not the recycled product by step 104 (S104), step 116 (S116), step 118 (S118), step 120 (S120) and step 122 (S122) are similarly jumped and the flowchart proceeds to step 124 (S124) and printing is done in the non-genuine product mode described above and the processing is ended.

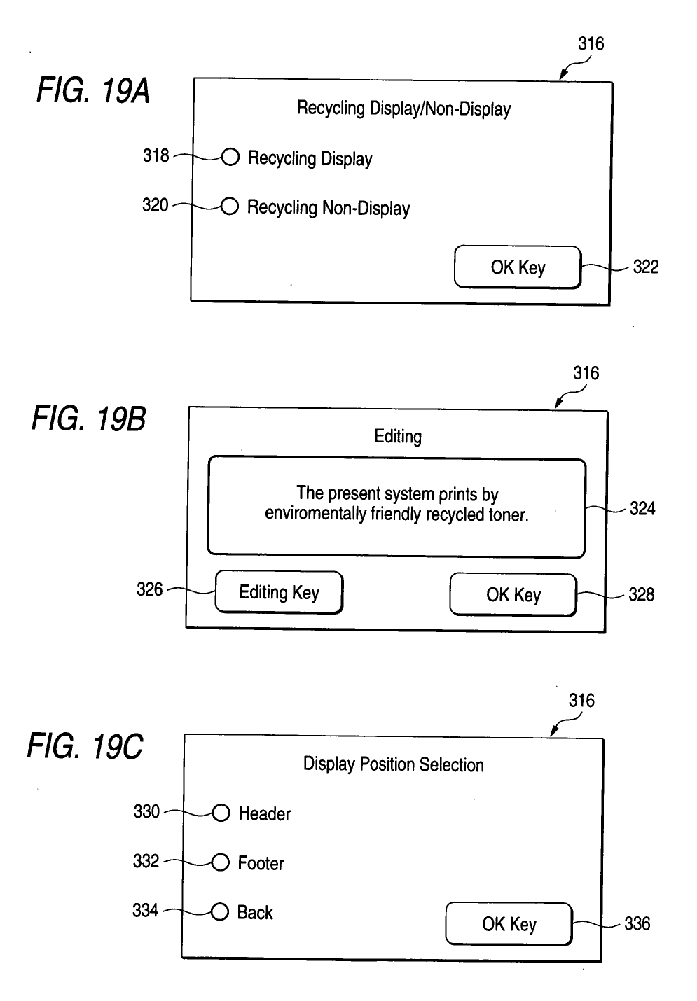

When it is determined that it is the recycled product in step 102 (S102) or step 104 (S104), the flowchart proceeds to step 106 (S106) or step 116 (S116) and it is determined whether recycling display is performed or not. In this step 106 (S106) or step 116 (S116), as shown in FIG. 19A, a recycling display selection part 318 and a recycling non-display selection part 320 are displayed on a display screen 316 of the user interface 18 of the image formation apparatus 10 or the host apparatus 2 and it is constructed so that a user can select any of the selection parts and a selection is confirmed by pressing an OK key 322 and it is determined whether recycling display is performed or not based on this selection of the user. When it is determined that the recycling display is not performed in step 106 (S106) or step 116 (S116), the flowchart proceeds to step 114 (S114) or step 124 (S124).

When it is determined that the recycling display is performed in step 106 (S106) or step 116 (S116), the flowchart proceeds to step 108 (S108) or step 118 (S118) and display editing is performed. In this step 108 (S108) or step 118 (S118), as shown in FIG. 19B, an editing screen 324 is displayed and also an editing key 326 and an OK key 328 are displayed on the display screen 316 of the user interface 18 of the image formation apparatus 10 or the host apparatus 2. As a default, for example, “the present system prints by environmentally friendly recycled toner” is displayed on the editing screen 324 and when the OK key 328 is pressed, the as-is text is printed on paper. When the editing key 326 is pressed, a text of the editing screen 324 can be edited and is confirmed by pressing the OK key 328.

In the next step 110 (S110) or step 120 (S120), as shown in FIG. 19C, display position selection parts 330, 332 and 334 are displayed on the display screen 316 of the user interface 18 of the image formation apparatus 10 or the host apparatus 2 and it is constructed so that, for example, a header, footer and the back can be selected, and a selection is confirmed by pressing an OK key 336.

In the next step 112 (S112) or step 122 (S122), the recycling display is added (combined) to a print image and in the next step 114 (S114) or step 124 (S124), the recycling display is printed on paper.

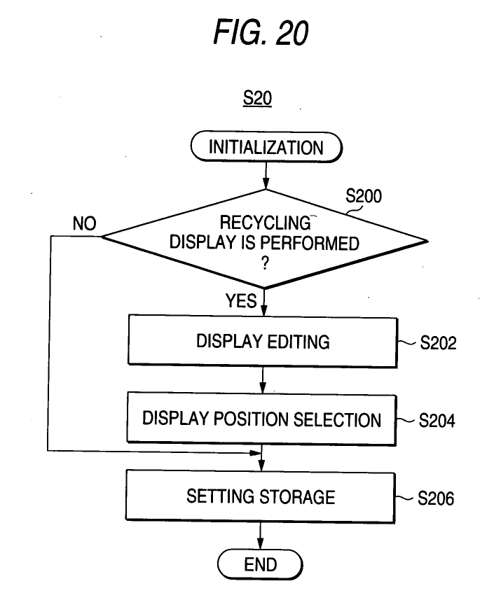

FIG. 20 is a flowchart (S20) showing a modified example of the embodiment.

In the embodiment, recycling display processing has been performed at the time of attaching a replacement unit, but in this modified example, recycling display processing is performed at the time of initialization.

That is, at the time of initialization, it is first determined whether recycling display is performed or not in step 200 (S200), and when it is determined that the recycling display is not performed, the flowchart proceeds to step 206 (S206) and when it is determined that the recycling display is performed, in the next step 202 (S202), the recycling display is edited and in the next step 204 (S204), a display position is selected and the flowchart proceeds to the next step 206 (S206) and these settings are stored in, for example, the body NVM 228 to end. When it is determined that a replacement unit is a recycled product at the time of attaching the replacement unit, setting information stored in the body NVM 228 in step 206 (S206) is read out and printing is executed according to the setting information.

Incidentally, in the embodiment, the case that a replacement unit is a toner cartridge has been described, but the invention is not limited to this and can also be applied to another replacement unit. Also, in the embodiment, one replacement unit has been described, but in the case of a color image formation apparatus, it may be constructed so as to determine whether a recycled product is used or not every color and print display to the effect that the recycled product is used every color on paper.

### Second Embodiment

An image formation apparatus and an image formation system of the second embodiment include configurations of the first embodiment that are explained by FIGS. 1 to 20. Therefore, in this embodiment, explanations of the overlapped configurations are omitted.

In this embodiment, details of data stored in the program ROM 224, the body NVM 228 and the unit NVM 184 will be described.

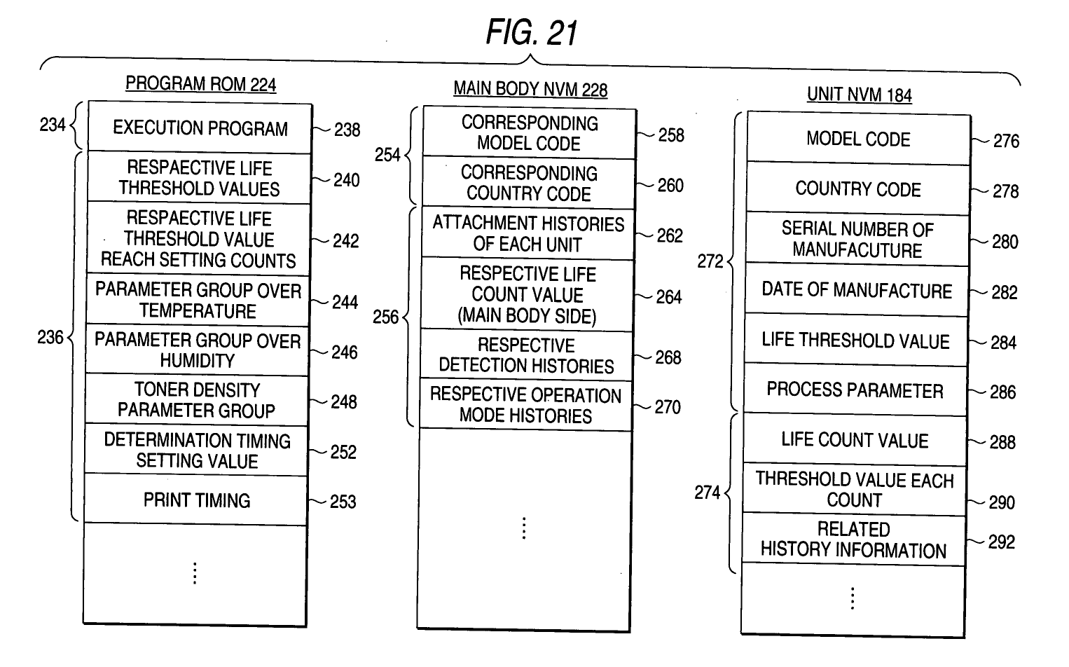

In FIG. 21, an example of data stored in the program ROM 224, the body NVM 228 and the unit NVM 184 is shown.

The program ROM 224 is provided with a program area 224 and a setting value area 236, etc. An execution program 238 for operating the image formation apparatus 10 is stored in the program area 224. Respective life threshold values 240, respective life threshold value reach setting counts 242, a parameter group 244 over temperature, a parameter group 246 over humidity, a toner density parameter group 248, a determination timing setting value 252, a print timing 1253, etc. are stored in the setting value area 236.

The respective life threshold values 240 include respective lives (life threshold values) of each of the replaceable units of the image formation apparatus 10. The respective life threshold value reach setting counts 242 include counts permitting each of the replaceable units of the image formation apparatus 10 to reach the life threshold values. The parameter group 244 over temperature includes each of the parameters about control over temperature of the image formation apparatus 10. The parameter group 246 over humidity includes each of the parameters about control over humidity of the image formation apparatus 10. The toner density parameter group 248 includes each of the parameters about control over a toner density of the inside of the developing device 48. The determination timing setting value 252 includes a period (determination timing) taken to start a determination as to whether to be a genuine product or a product other than the genuine product with respect to each of the replaceable units of the image formation apparatus 10 by the CPU 202 in processing etc. in which the image formation apparatus 10 makes printing preparations according to an operation mode.

The print timing 1253 includes, for example, a power-on time, a predetermined sheet printing time, an internal specification time, and an external specification time, and stores a period of display of that the replaceable unit is a product other than a genuine product when the replaceable unit is the product other than the genuine product, as described below.

The body NVM 228 is provided with a corresponding unit information area 254 and a body side updating area 256, etc.

A corresponding model code 258 and a corresponding country code 260 are stored in the corresponding unit information area 254. The corresponding model code 258 stores a table (data) of models indicating that it is a model adapted for the image formation apparatus 10 with respect to each of the replaceable units of the image formation apparatus 10. The corresponding country code 260 stores a table (data) of each of the countries in which different specifications are set every country with respect to each of the replaceable units of the image formation apparatus 10.

Attachment histories 262 of each unit, respective life count values 264 of the body side, respective life threshold value reach counts 266 of the body side, respective detection histories 268 and respective operation mode histories 270, etc. are stored in the body side updating area 256. The attachment histories 262 of each unit include the respective attachment histories of each of the replaceable units of the image formation apparatus 10. Also, the fact that a genuine product is attached is stored in initial states (initial values) of the attachment histories 262 of each unit. The respective life count values 264 of the body side include the respective life count values (the amount of use to the present time since a start of use) of each of the replaceable units of the image formation apparatus 10. Incidentally, the amount of use of each unit may be calculated from the respective accumulated operating time etc. of each unit. The respective life threshold value reach counts 266 of the body side include the respective life threshold value reach counts of each of the replaceable units of the image formation apparatus 10. The respective detection histories 268 include histories of detection results detected by the respective sensors etc. provided in the image formation apparatus 10. The respective operation mode histories 270 include histories of operation modes respectively applied to each of the replaceable units of the image formation apparatus 10.

The unit NVM 184 is provided with a unit information area 272 and a unit side updating area 274, etc.

A model code 276 indicating a model, a country code 278 indicating a country in which specifications are set, a serial number 280 of manufacture specific to a unit, a date 282 of manufacture, a life threshold value 284 indicating a life of a unit and a process parameter 286 for process control, etc. are stored in the unit information area 272.

A life count value 288 indicating the amount of use to the present time since a start of use of the toner cartridge 52, a life threshold value reach count 290 indicating a count reaching a life threshold value stored in the life threshold value 284, related history information 292, flag information 294 for determining whether to be a new product or a recycled product, etc. are stored in the unit side updating area 274. Incidentally, the related history information 292 includes a history of available related information in order to grasp a state of the toner cartridge 52, for example, the number of rotations of the image carrier 54.

When an image formation signal is sent in the image formation apparatus 10 of the configuration described above, the image carrier 54 is uniformly electrified by the electrification device 60 and a light beam is emitted from the light exposure device 68 to this electrified image carrier 54 based on an image signal. The light beam from the light exposure device 68 exposes a surface of the image carrier 54 and a latent image is formed.

The latent image carried to the image carrier 54 is developed by the developing device unit 44 in a development position. In the developing device unit 44, toners of yellow, magenta, cyan and black are respectively supplied from the toner cartridges 52a to 52d to the developing devices 48a to 48d. Also, developers redundantly supplied to the developing devices 48a to 48d are respectively recovered to the toner cartridges 52a to 52d. By the developing devices 48a to 48d of the developing device unit 44, a toner image developed every color is superimposed on the intermediate transfer body 74 and is primarily transferred. In the primary transfer, the waste toner remaining on the image carrier 54 is scraped and recovered by the cleaner 62 for image carrier.

On the other hand, paper accommodated in the paper feeding cassette 24 by a paper feeding signal etc. is fed by the feed roll 26 and is handled by the retard roll 28 and is guided to the transport path 34 and is temporarily stopped by the resist roll 38 and is guided between the secondary transfer roll 88 and the secondary transfer backup roll 82 with timing. When the paper is guided between the secondary transfer roll 88 and the secondary transfer backup roll 82, a toner image superimposed on the intermediate transfer body 74 in four colors by primary transfer is secondarily transferred to the paper by the secondary transfer roll 88 and the secondary transfer backup roll 82. After the secondary transfer, the waste toner remaining on the intermediate transfer body 74 is scraped and recovered by the cleaner 92 for intermediate transfer body.

The paper to which the toner image is transferred is guided to the fixing device 100 and the toner image is fixed by thermal pressure by the heating roll 102 and the pressurizing roll 104. The paper to which the toner image is fixed is delivered from the delivery outlet 36 to the delivery part 42 by the delivery roll 40. The control part 106 stores a life count value etc. of the toner cartridge 52 in the unit NVM 184 and the body NVM 228.

Further, in this embodiment, the image formation apparatus 10 controls display etc. by the UI device 18 based on data stored in the storage part 204 and the unit NVM 184. For example, by control of the CPU 202, the UI device 18 displays the remaining amount of toner when the toner cartridge 52 is a genuine product, and displays the use amount of toner when the toner cartridge 52 is a product other than the genuine product. This is because the remaining amount of toner cannot be calculated since the amount of toner is unknown when it is the product other than the genuine product.

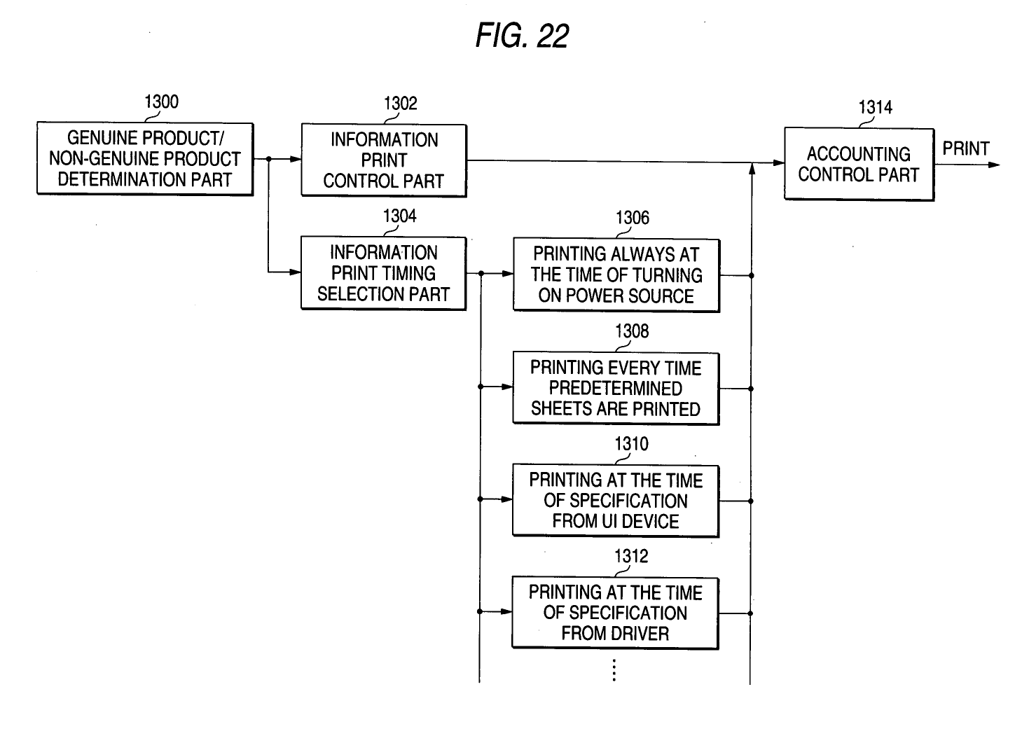

Further, in this embodiment, as shown in FIG. 22, the execution program 238 has an information print control part 1302 for controlling whether information about paper is printed or not.

Also, the execution program 238 has an information print timing selection part 1304 for selecting any timing at which information about paper is printed. This information print timing selection part 1304 has, for example, a power-on time selection part 1306 for making setting so as to do printing always at the time of turning on a power source, a predetermined sheet basis selection part 1308 for making setting so as to do printing every time predetermined sheets are printed, an internal specification time selection part 1310 for doing printing at the time of being specified from the UI device 18, and an external specification time selection part 1312 for doing printing at the time of being specified from the host apparatus 2. The predetermined sheet time selection part 1308 prints information to paper at the stage of being printed to, for example, 200 sheets of paper. In the case of a user who does not turn off a power source, the user can be made to recognize by printing information on a predetermined sheet basis.

Further, the execution program 238 has an accounting control part 1314 for controlling whether or not accounting is performed with respect to printing of paper.

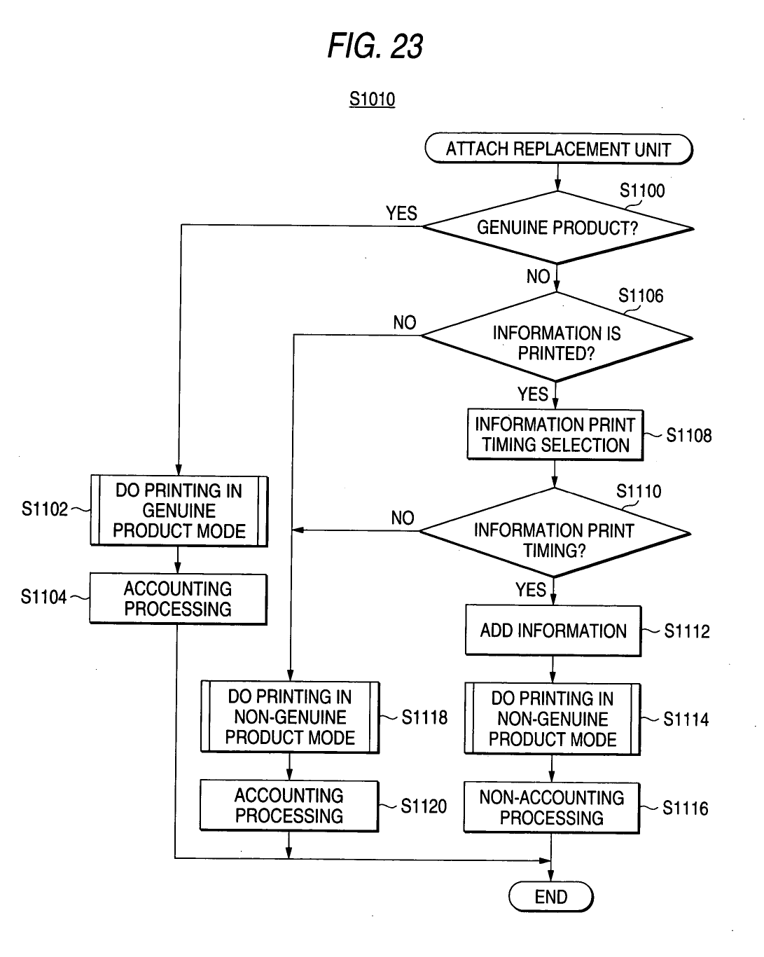

FIG. 23 is a flowchart (S1010) showing a control flow of the case of attaching a replacement unit.

When a replacement unit is attached, it is first determined whether the replacement unit is a genuine product or a product other than the genuine product in step 1100 (S1100). When it is determined that the replacement unit is the genuine product, the flowchart proceeds to step 1102 (S1102) and printing is done in the genuine product mode described above and further, accounting processing is performed in step 1104 (S1104) and the processing is ended.

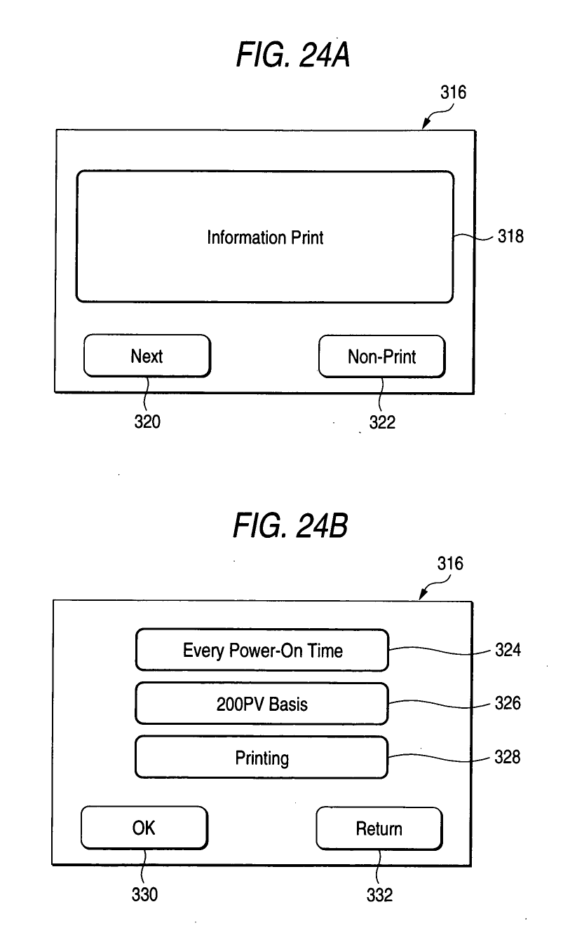

When it is determined that the replacement unit is not the genuine product, that is, the product other than the genuine product in step 1100 (S1100), it is determined whether information is printed or not in the next step 1106 (S1106). In this step 1106 (S1106), as shown in FIG. 24A, an information print selection screen 318, a next selection key 320 and a non-print key 322 are displayed on a display screen 316 of the UI device 18 and determination of the step 1106 (S1106) shifts to Y by pressing the next selection key 320 and determination of the step 1106 (S1106) shifts to N by pressing the non-print key 322.

When it is determined that the information is printed (Y) in step 1106 (S1106), the flowchart proceeds to the next step 1108 (S1108) and in this step 1108 (S1108), as shown in FIG. 24B, for example, a power-on time selection key 324, a predetermined sheet basis selection key 326 and a specification time selection key 328 are displayed on the display screen 316 of the UI device 18 and a user can select any of the keys. Also, an OK key 330 and a return key 332 are displayed on the display screen 316 of the UI device 18 and when the user selects any of the selection keys 324, 326, 328 and presses the OK key 330, the selection is confirmed and the flowchart proceeds to the next step 1110 (S1110). On the other hand, when the user presses the return key 332, it returns to the screen of FIG. 24A. When the power-on time selection key 324 is selected, the fact that a product other than the genuine product is attached to a replacement unit is printed on paper every time a power source is turned on in the image formation apparatus 10. When the predetermined sheet basis selection key 326 is selected, the fact that a product other than the genuine product is attached to a replacement unit is printed on paper every time, for example, 200 sheets of paper are printed. When the specification time selection key 328 is selected, the fact that a product other than the genuine product is attached to a replacement unit is immediately printed on paper.

In step 1110 (S1110), it is determined whether or not it is at timing of information print set in step 1108 (S1108). When it is determined that it is at the information print timing in this step 1110 (S1110), the flowchart proceeds to step 1112 (S1112) and information (information to the effect that a replacement unit is a product other than a genuine product) is added and the flowchart proceeds to the next step 1114 (S1114) and printing is done in the non-genuine product mode described above and the flowchart proceeds to the next step 1116 (S1116) and non-accounting processing is performed and the processing is ended. The reason why information to the effect that a replacement unit is a product other than a genuine product is printed is because a user is urged to exercise caution, so that the non-accounting processing (processing in which accounting is not performed with respect to printing) is performed in step 1116 (S1116).

On the other hand, when it is determined that it is not at the information print timing in step 1110 (S1110), the flowchart proceeds to step 1118 (S1118) and printing is done in the non-genuine product mode described above and the flowchart proceeds to the next step 1120 (S1120) and accounting processing is performed and the processing is ended.

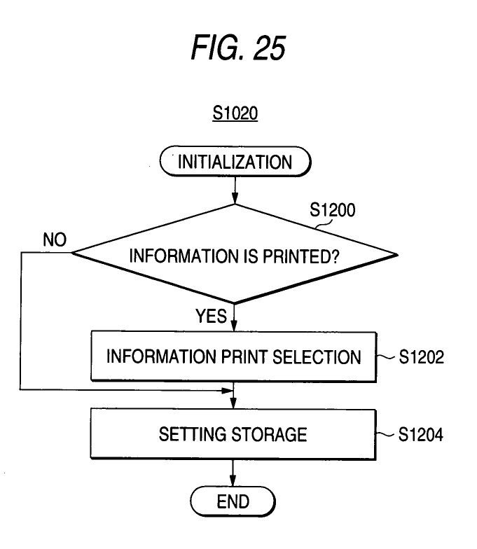

FIG. 25 is a flowchart (S1020) showing a first modified example of the embodiment.

In the embodiment, information print setting processing has been performed at the time of attaching a replacement unit, but in this modified example, information print setting processing is performed at the time of initialization.

That is, at the time of initialization, it is first determined whether information is printed or not in step 1200 (S1200), and when it is determined that the information is printed, the flowchart proceeds to the next step 1202 (S1202) and an information print selection is made and the flowchart proceeds to the next step 1204 (S1204) and information print setting is stored in, for example, the body NVM 228 to end. On the other hand, when it is determined that the information is not printed in step 1200 (S1200), that is, when it is determined that a replacement unit is a recycled product at the time of attaching the replacement unit, step 1202 (S1202) is jumped and the flowchart proceeds to step 1204 (S1204) and the fact to the effect that the information is not printed is stored in, for example, the body NVM 228 to end. Setting information stored in the body NVM 228 in step 1204 (S1204) is read out and printing is executed according to the setting information.

Next, a second modified example of the image formation apparatus according to the embodiment of the invention will be described. In this second modified example, setting of information print is made from a host apparatus 2.

A Web server (also called WWW server or http server) is further included in a program area 234 which an image formation apparatus 10 has. The Web server is means for communicating with the host apparatus 2 by http (HyperText Transfer Protocol).

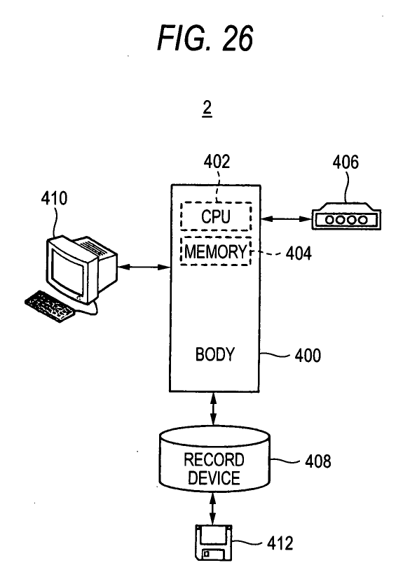

FIG. 26 is a diagram showing a hardware configuration of the host apparatus 2 shown in FIG. 1.

As shown in FIG. 26, the host apparatus 2 has a body 400 including a CPU 402 and memory 404, etc., a display and input device 410 including a liquid crystal display, a keyboard and a mouse (not shown), a record device 408 such as an HDD and CD device, and a communication device 406 for communicating with a network. That is, the host apparatus 2 includes a configuration part acting as a general computer capable of communication through the network.

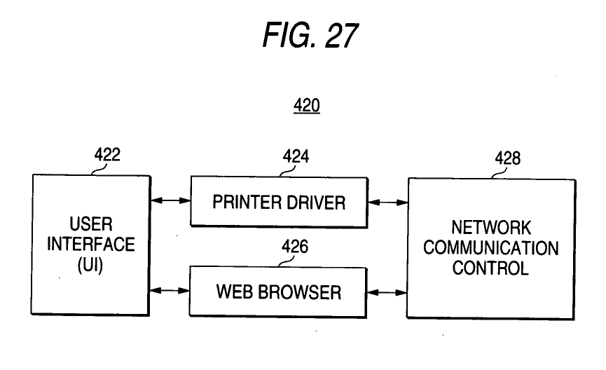

FIG. 27 is a diagram showing a configuration of a client program 420 operating on the host apparatus 2 shown in FIG. 1.

As shown in FIG. 27, the client program 420 has a user interface (UI part) 422, a printer driver 424, a Web browser 426 and a network communication control part 428.

The client program 420 is supplied to the record device 408 of the host apparatus 2 through, for example, a record medium 412 and is loaded into the memory 404 and is executed. By these components, the client program 420 provides a state viewing function and a setting change function, etc. of the image formation apparatus 10 for a user using the host apparatus 2, and displays a message etc. sent from the image formation apparatus 10 through a network 3.

In the client program 420, the UI part 422 receives an operation of a user to the display and input device 410 and controls processing of each of the components of the client program 420. Also, the UI part 422 displays data received through the network 3 by the printer driver 424 or the Web browser 426 with respect to the user.

The printer driver 424 provides a state viewing function and a setting function of the image formation apparatus 10 for a user of the host apparatus 2. Also, the printer driver 424 provides a message notification function from the image formation apparatus 10. The client program 420 may include a utility program having a function equivalent to that of the printer driver 424. The utility program is means having a setting function and a state viewing function, etc. of an apparatus connected to a network without specializing in a particular image formation apparatus.

The Web browser 426 provides a state viewing function and a setting function of the image formation apparatus 10 for a user of the host apparatus 2 through a Web server operating on the image formation apparatus 10.

The network communication control part 428 controls communication with the image formation apparatus 10 connected through the network 3 shown in FIG. 1.

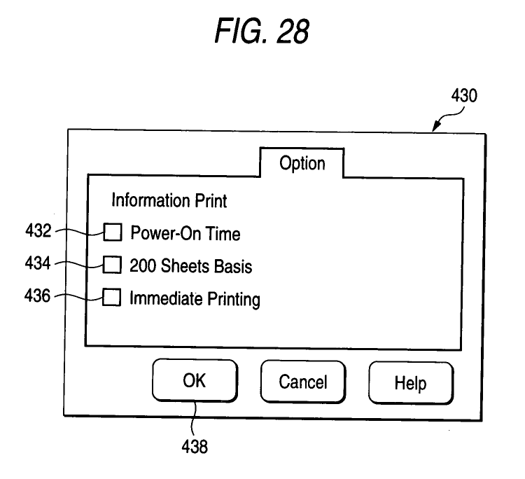

An information print setting function is included in the setting function provided from the printer driver 424 described above. FIG. 28 shows an information print setting screen 430 provided from the printer driver 424. The information print setting screen 430 is provided with a checkbox 432 for power-on time selection, a checkbox 434 for predetermined sheet basis selection and a checkbox 436 for specification time selection, and by selecting any of the checkboxes and pressing an OK button 438, information print timing is set.

Incidentally, in the embodiment, the case that a replacement unit is a toner cartridge has been described, but the invention is not limited to this and can also be applied to another replacement unit. Also, in the embodiment, one replacement unit has been described, but in the case of a color image formation apparatus, it may be constructed so as to determine whether a recycled product is used or not every color and print display to the effect that the recycled product is used every color on paper.

1. An image formation apparatus comprising:
an apparatus body;
at least one replacement unit replaceably attached to this apparatus body;
a determination unit for determining whether this replacement unit is a recycled product or not; and
a control unit for performing control so that display to the effect that the recycled product is used is printed on paper in the case of determining that the replacement unit is recycling as a result of determination of the determination unit.

2. The image formation apparatus according to claim 1, further comprising
a display/non-display selection unit for selecting whether display to the effect that the recycled product is used is performed or not.

3. The image formation apparatus according to claim 1, further comprising
an editing unit for editing a form of display to the effect that the recycled product is used.

4. The image formation apparatus according to claim 1, further comprising
a display position selection unit for selecting a position of display to the effect that the recycled product is used with respect to paper.

5. The image formation apparatus according to claim 1, wherein
a plurality of the replacement units are had every color and the control unit performs display to the effect that the recycled product is used every color.

6. An image formation apparatus comprising:
an apparatus body;
at least one replacement unit replaceably attached to this apparatus body;
a first determination unit for determining whether this replacement unit is a genuine product or a product other than the genuine product;
a second determination unit for determining whether the replacement unit is a recycled product or not; and
a control unit for performing control so that display to the effect that the recycled product is used is printed on paper in the case of determining that the replacement unit is the product other than the genuine product as a result of determination of the first determination unit and determining that the replacement unit is recycling as a result of determination of the second determination unit.

7. An image formation apparatus comprising:
an apparatus body,
at least one replacement unit replaceably attached to this apparatus body,
a first determination unit for determining whether this replacement unit is a genuine product or a product other than the genuine product,
a second determination unit for determining whether the replacement unit is a recycled product or not, and
a control unit for performing control so that display to the effect that the recycled product is used is printed on paper in the case of determining that the replacement unit is the genuine product as a result of determination of the first determination unit and determining that the replacement unit is recycling as a result of determination of the second determination unit.

8. An image formation apparatus having:
an apparatus body;
at least one replacement unit replaceably attached to this apparatus body;
a determination unit for determining whether this replacement unit is a genuine product or a product other than the genuine product; and
a control unit for performing control so that in the case of determining that the replacement unit is the product other than the genuine product as a result of determination of the determination unit, printing to that effect is done on paper.

9. The image formation apparatus according to claim 8, wherein
a plurality of the replacement units are had every color and the control unit performs display to the effect that the product other than the genuine product is used every color.

10. The image formation apparatus according to claim 8, further comprising
a print timing selection unit for selecting print timing to the effect that the replacement unit is the product other than the genuine product with respect to paper.

11. The image formation apparatus according to claim 10, wherein
the print timing selection unit has a power-on time selection part for making a selection so as to do printing to the effect that the replacement unit is the product other than the genuine product with respect to paper at the time of turning on a power source.

12. The image formation apparatus according to claim 10, wherein
the print timing selection unit has a predetermined sheet basis selection part for making a selection so as to do printing to the effect that the replacement unit is the product other than the genuine product with respect to paper on a predetermined sheet print basis.

13. The image formation apparatus according to claim 10, wherein
the print timing selection unit has a specification time selection part for making a selection so as to do printing to the effect that the replacement unit is the product other than the genuine product with respect to paper at the time of specification.

14. The image formation apparatus according to claim 13, wherein
the specification time print selection part makes a selection so as to do printing to the effect that the replacement unit is the product other than the genuine product with respect to paper according to a specification signal from the outside.

15. The image formation apparatus according to claim 8, further comprising
an accounting unit for performing accounting with respect to printing of paper and having an accounting control unit for performing non-accounting with respect to printing of paper on which printing to the effect that the replacement unit is the product other than the genuine product is done by the control unit.

16. An image formation system comprising:
an image formation apparatus; and
a host apparatus connected to this image formation apparatus, wherein:
the image formation apparatus has:
an apparatus body;
at least one replacement unit replaceably attached to this apparatus body;
a determination unit for determining whether this replacement unit is a genuine product or a product other than the genuine product; and
a control unit for performing control so that in the case of determining that the replacement unit is the product other than the genuine product as a result of determination of the determination unit, printing to that effect is done on paper; and
the host apparatus has a print timing selection unit for selecting print timing to the effect that the replacement unit is the product other than the genuine product with respect to paper.
